(19) United States
(12) Patent Application Publication
(10) Pub. No.: US 2026/0350395 A1
(43) Pub. Date: Nov. 5, 2026

(54) NN GROWTH APPARATUS, INFORMATION PROCESSING APPARATUS, METHOD FOR PRODUCING NEURAL NETWORK INFORMATION, AND PROGRAM

(71) Applicant: SOFTBANK CORP., Tokyo (JP)

(72) Inventor: Yuko ISHIWAKA, Tokyo (JP)

(21) Appl. No.: 19/123,591

(22) PCT Filed: Nov. 14, 2022
(86) PCT No.: PCT/JP2022/042235

§ 371 Date: Apr. 23, 2025

(51) Int. Cl. G06N 3/082

(52) U.S. Cl. CPC G06N 3/082

(57) ABSTRACT

An NN growth apparatus includes: an overall score acquisition unit that acquires an overall score based image feature information and sound feature information; a firing node determination unit that determines one or more node identifiers paired with an initial firing condition satisfied by the image feature information and the sound feature information, and determines, for each of the nodes identified by the one or more node identifiers, a node identifier of a firing node that is connected by an edge, receives one or more kinds of information of the image feature information and the sound feature information; and a growth unit that performs growth processing to grow edge information of one or more edges connected to each of one or more nodes identified by one or more node identifiers of the determined one or more node identifiers, based on difference information between the overall score and the reference score.

### TECHNICAL FIELD

The present invention relates to, for example, an NN growth apparatus, which is an apparatus that virtually realizes the mechanism of brain growth.

### BACKGROUND ART

Conventionally, there have been electroencephalogram signal processing apparatuses that acquire and process electroencephalogram signals that represent the electroencephalograms of a subject (see Patent Documents 1 and 2, for example).

### CITATION LIST

### Patent Documents

Patent Document 1: JP 2016-47239A
Patent Document 2: JP 2016-52430A

### SUMMARY OF INVENTION

### Technical Problem

However, the conventional techniques have not been able to simulate the development of a brain.

### Solution to Problem

An NN growth apparatus according to a first aspect of the present invention is an NN growth apparatus including: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information each containing one or more node identifiers identifying nodes that fire without going through other nodes are stored, in association with an initial firing condition that is a condition related to one or more kinds of feature information of one or more pieces of image feature information for image information and one or more pieces of sound feature information for sound information, and that is a condition for determining nodes that fire without going through other nodes; a reference score storage unit in which a reference score related to a positive state or a negative state is stored; an information acceptance unit that accepts image information and sound information; an image feature acquisition unit that acquires, using the image information accepted by the information acceptance unit, one or more pieces of image feature information corresponding to the image information; an overall score acquisition unit that acquires an overall score based on the one or more pieces of image feature information and the one or more pieces of sound feature information; an image score acquisition unit that acquires an image score that is a score related to positive and negative states, using the one or more pieces of image feature information; a sound feature acquisition unit that acquires, using the sound information accepted by the information acceptance unit, one or more pieces of sound feature information corresponding to the sound information; a sound score acquisition unit that acquires a sound score that is a score related to positive and negative states, using the one or more pieces of sound feature information; an overall score acquisition unit that acquires an overall score, using the image score and the sound score; a firing node determination unit that determines, from the start point storage unit, one or more node identifiers paired with the initial firing condition that matches one or more kinds of information of the one or more pieces of image feature information and the one or more pieces of sound feature information, and determines, for each of the nodes identified by the one or more node identifiers, a node identifier of a firing node that is connected by an edge, receives one or more kinds of information of the one or more pieces of image feature information and the one or more pieces of sound feature information; and a growth unit that performs growth processing to grow edge information of one or more edges connected to each of one or more nodes identified by one or more node identifiers of the one or more node identifiers determined by the firing node determination unit, based on difference information regarding a difference between the overall score and the reference score.

With such a configuration, it is possible to simulate brain growth.

An NN growth apparatus according to a second aspect of the present invention is the NN growth apparatus according to the first aspect of the invention, further including: an image score acquisition unit that acquires an image score that is a score related to positive and negative states, using the one or more pieces of image feature information; a sound feature acquisition unit that acquires, using the sound information accepted by the information acceptance unit, one or more pieces of sound feature information corresponding to the sound information; and a sound score acquisition unit that acquires a sound score that is a score related to positive and negative states, using the one or more pieces of sound feature information, wherein the overall score acquisition unit uses the image score and the sound score to acquire the overall score.

With such a configuration, it is possible to simulate brain growth.

An NN growth apparatus according to a third aspect of the present invention is the NN growth apparatus according to the first or the second aspect of the invention, wherein the edge information contains a weight, the firing node determination unit determines a node identifier of a node that is connected by an edge whose weight satisfies a transfer condition, and the growth unit performs first edge growth processing to acquire difference information regarding a difference between the overall score and the reference score, and to increase the weight of the edge information of each of the one or more edges when the difference information matches a first edge growth condition.

With such a configuration, it is possible to simulate brain growth.

An NN growth apparatus according to a fourth aspect of the present invention is the NN growth apparatus according to the first or the second aspect of the invention, wherein the edge information may contain edge position information that specifies a position of an end point of an edge, and the growth unit performs second edge growth processing to acquire difference information regarding a difference between the overall score and the reference score, and to change the edge position information contained in the edge information of each of the one or more edges when the difference information matches a second edge growth condition, thereby increasing a length of each edge.

With such a configuration, it is possible to simulate brain growth.

An NN growth apparatus according to a fifth aspect of the present invention is the NN growth apparatus according to the fourth aspect of the invention, further including: a goal storage unit in which pieces of goal information are stored, the pieces of goal information specifying goals respectively corresponding to two or more states that include positive and negative states; and a state determination unit that determines one state from the two or more states including the positive and negative states, using the difference information acquired by the growth unit, wherein the pieces of goal information each contain goal position information that specifies a position of the goal corresponding thereto, or goal direction information that indicates a direction of the goal, and the growth unit acquires the goal information paired with the one state determined by the state determination unit, changes the edge position information contained in the edge information of each of the one or more edges, acquires a new piece of edge position information in the direction indicated by the goal information, and performs the second edge growth processing to accumulate the new piece of edge position information. With such a configuration, it is possible to simulate brain growth.

An NN growth apparatus according to a sixth aspect of the present invention is the NN growth apparatus according to any one of the first to fifth aspects of the invention, further including: a reference score change unit that changes the reference score in the reference score storage unit based on the overall score acquired by the overall score acquisition unit.

With such a configuration, it is possible to simulate brain growth.

An NN growth apparatus according to a seventh aspect of the present invention is the NN growth apparatus according to the sixth aspect of the invention, wherein the reference score change unit changes the reference score in the reference score storage unit only when the overall score matches a score change condition.

With such a configuration, it is possible to simulate brain growth.

An NN growth apparatus according to an eighth aspect of the present invention is the NN growth apparatus according to any one of the first to seventh aspects of the invention, wherein the reference score storage unit stores a reference score paired with one or more firing patterns that use one or more node identifiers, and the growth unit acquires the reference score paired with the firing pattern corresponding to the one or more node identifiers determined by the firing node determination unit from the reference score storage unit, acquires difference information regarding a difference between the overall score and the reference score, and performs the growth processing based on the difference information.

With such a configuration, it is possible to simulate brain growth.

An NN growth apparatus according to a ninth aspect of the present invention is the NN growth apparatus according to any one of the first to eighth aspects of the invention, wherein the firing node determination unit judges whether or not one or more pieces of feature information transferred from one or more other nodes connected by edges satisfy one or more firing conditions related to the feature information, and determines the node identifier of a node judged to satisfy the firing conditions.

With such a configuration, it is possible to simulate brain growth.

An NN growth apparatus according to a tenth aspect of the present invention is the NN growth apparatus according to the first aspect of the invention, wherein the node information contains node position information that specifies a position of the node, the NN growth apparatus further includes: a goal storage unit in which pieces of goal information are stored, the pieces of goal information specifying goals respectively corresponding to two or more states that include positive and negative states; and a state determination unit that determines one state from the two or more states including the positive and negative states, using the difference information acquired by the growth unit, and the growth unit acquires difference information regarding a difference between the overall score and the reference score, and, based on the difference information, performs edge generation processing to generate and accumulate edge information corresponding to one or more edges extending from one or more nodes identified by one or more node identifiers of the one or more node identifies determined by the firing node determination unit in a direction indicated by the goal information paired with the one state determined by the state determination unit.

With such a configuration, it is possible to simulate brain growth.

An NN growth apparatus according to an eleventh aspect of the present invention is the NN growth apparatus according to the tenth aspect of the invention, wherein the firing node determination unit accumulates count information related to a count of the determined node identifiers in association with the node identifiers, and the growth unit performs the edge generation processing on a node identified by a node identifier corresponding to the count information that matches an edge generation condition.

With such a configuration, it is possible to simulate brain growth.

An NN growth apparatus according to a twelfth aspect of the present invention is the NN growth apparatus according to any one of the first to eleventh aspects of the invention, wherein each node is a soma, the edges include an axon and a dendrite, and the edge information contains axon information that contains an axon identifier and axon position information indicating a position of the axon, and dendrite information that contains a dendrite identifier and dendrite position information indicating a position of the dendrite.

With such a configuration, it is possible to simulate brain growth.

An information processing apparatus according to a thirteenth aspect of the present invention is an information processing apparatus including: an NN storage unit in which neural network information accumulated by an NN growth apparatus is stored; an information acceptance unit that accepts acceptance information that is one or more kinds of information selected from the group consisting of image information and sound information; a feature acquisition unit that acquires one or more pieces of feature information corresponding to the acceptance information accepted by the information acceptance unit; an information transfer unit that determines one or more node identifiers of one or more firing nodes, corresponding to the one or more pieces of feature information acquired by the feature acquisition unit, from a start point storage unit in which one or more pieces of firing start point information are stored, each piece of firing start point information containing an information identifier that identifies feature information of acceptance information and one or more node identifiers that identify nodes that fire without going through other nodes when the feature information is accepted, and determines a node identifier of a firing node that is connected to the one or more nodes identified by the one or more node identifiers by edges and to which the feature information is to be transferred; a firing pattern acquisition unit that acquires a firing pattern using the one or more node identifiers determined by the information transfer unit; an output information acquisition unit that acquires output information corresponding to the firing pattern acquired by the firing pattern acquisition unit; and an information output unit that outputs the output information.

With such a configuration, it is possible to simulate brain activity using a model of a grown brain.

An information processing apparatus according to a fourteenth aspect of the present invention is the thirteenth aspect of the invention, further including: a temperature acceptance unit that accepts temperature information, wherein the information transfer unit performs information transfer processing to transfer, from a node that has fired, the feature information corresponding to the node that has fired, to a node that is to fire next, and changes a processing time for the information transfer processing based on the temperature information accepted by the temperature acceptance unit.

With such a configuration, it is possible to simulate brain activity using a model of a grown brain.

### Advantageous Effects of Invention

The NN growth apparatus according to the present invention can simulate brain growth.

### BRIEF DESCRIPTION OF DRAWINGS

FIG. 1 is a block diagram of an NN growth apparatus 1 according to a first embodiment.

FIG. 2 is a flowchart illustrating examples of operations of the NN growth apparatus 1 according to the same.

FIG. 3 is a flowchart illustrating an example of score obtaining processing according to the same.

FIG. 4 is a flowchart illustrating an example of growth processing according to the same.

FIG. 5 is a flowchart illustrating an example of initial firing node determination processing according to the same.

FIG. 6 is a flowchart illustrating an example of firing transfer processing according to the same.

FIG. 7 is a flowchart illustrating an example of firing judgment processing according to the same.

FIG. 8 is a flowchart illustrating an example of firing judgment processing according to the same.

FIG. 9 is a flowchart illustrating an example of single growth processing according to the same.

FIG. 10 is a flowchart illustrating an example of edge growth processing according to the same.

FIG. 11 is a flowchart illustrating an example of edge extension processing according to the same.

FIG. 12 is a flowchart illustrating an example of edge generation processing according to the same.

FIG. 13 is a flowchart illustrating an example of edge information generation processing according to the same.

FIG. 14 is a flowchart illustrating an example of node generation processing according to the same.

FIG. 15 is a flowchart illustrating an example of node information generation processing according to the same.

FIG. 16 is a flowchart illustrating an example of reference change processing according to the same.

FIG. 17 is a block diagram of an information processing apparatus 2 according to a second embodiment.

FIG. 18 is a flowchart illustrating examples of operations of the information processing apparatus 2 according to the same.

FIG. 19 is a flowchart illustrating an example of information transfer processing according to the same.

FIG. 20 is a flowchart illustrating an example of subsequent transfer processing according to the same.

FIG. 21 is a flowchart illustrating an example of firing judgment processing according to the same.

FIG. 22 is a block diagram of an information processing apparatus 3 according to the same.

FIG. 23 is an overview diagram of a computer system according to the above embodiments.

FIG. 24 is a block diagram of the computer system according to the same.

### DESCRIPTION OF EMBODIMENTS

Hereinafter, embodiments of an NN growth apparatus and so on will be described with reference to the drawings. Note that in the embodiments, constituent elements with the same reference signs perform similar operations, and therefore, repeated descriptions thereof may be omitted.

### First Embodiment

The present embodiment describes an NN growth apparatus that accepts image information and sound information, obtains an overall score using image feature information acquired from the image information and sound feature information acquired from the sound information, and performs growth processing based on the difference between the overall score and a reference score. The processing here refers to, for example, edge growth processing, edge generation processing, and node generation processing.

The edge growth processing is processing performed to grow an edge included in a neural network (hereinafter referred to as an “NN” where appropriate). The processing performed to grow an edge includes, for example, first edge growth processing performed to increase the weight of an edge, and second edge growth processing performed to increase the length of an edge. The edge generation processing is processing performed to generate a new edge. Node generation processing is processing performed to generate nodes that are to be included in the NN.

It is preferable that the neural network here is a spiking neural network. However, the neural network may be other types of neural networks, such as a deep neural network. That is to say, there is no limitation on the type of neural network.

Note that, in the present embodiment, for example, when the difference between the overall score and the reference score is small, the weight of the edge is increased. In the present embodiment, for example, when the difference between the overall score and the reference score is large, the length of the edge is increased. Also, in the present embodiment, when the length of an edge is to be increased, for example, the edge is grown in a direction according to the acquired state (for example, a positive state or a negative state).

The present embodiment also describes a case in which an image score that is based on image feature information and a sound score that is based on sound feature information are obtained, and an overall score is obtained using the image score and the sound score.

The present invention also describes a NN growth apparatus in which the reference score changes dynamically. For example, the reference score changes only when the overall score matches a score change condition.

The present embodiment also describes an NN growth apparatus in which reference scores corresponding to firing patterns are stored.

The present embodiment also describes an NN growth apparatus that fires only the nodes that match the firing condition.

The present embodiment also describes an NN growth apparatus in which the nodes are somas and the edges include axons and dendrites

In this specification, the state in which information X is associated with information Y means that the information Y can be acquired from the information X or the information X can be acquired from the information Y, and there is no limitation on the method for associating the information. The information X and the information Y may be linked to each other or in the same buffer. The information X may be contained in the information Y, or the information Y may be contained in the information X, for example.

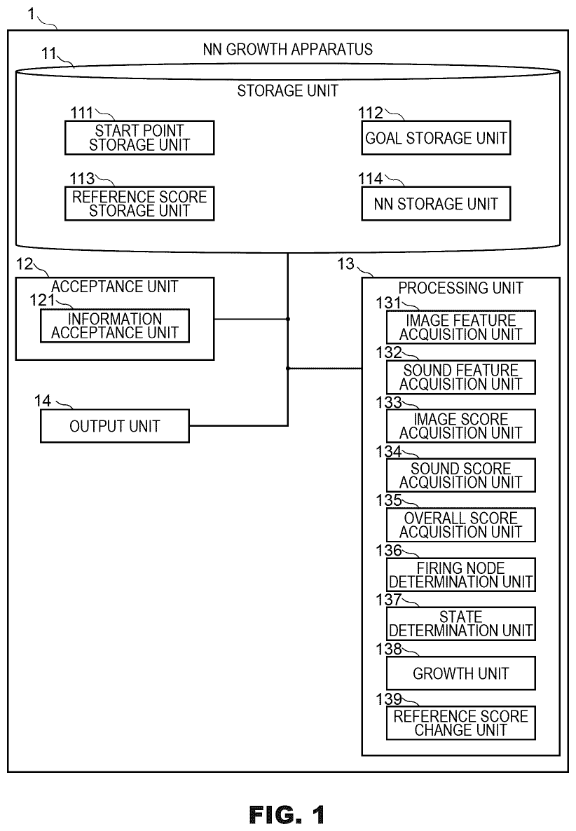

FIG. 1 is a block diagram of an NN growth apparatus 1 according to the present embodiment. The NN growth apparatus 1 includes a storage unit 11, an acceptance unit 12, a processing unit 13, and an output unit 14. The storage unit 11 includes a start point storage unit 111, a goal storage unit 112, a reference score storage unit 113, and an NN storage unit 114. The acceptance unit 12 includes an information acceptance unit 121. The processing unit 13 includes an image feature acquisition unit 131, a sound feature acquisition unit 132, an image score acquisition unit 133, a sound score acquisition unit 134, an overall score acquisition unit 135, a firing node determination unit 136, a state determination unit 137, a growth unit 138, and a reference score change unit 139.

The storage unit 11 included in the NN growth apparatus 1 stores various kinds of information. Examples of the various kinds of information include firing start point information, which will be described later, goal information, which will be described later, a reference score, which will be described layer, a neural network (NN), one or more pieces of glial cell information, which will be described later, one or more pieces of connection information, which will be described later, one or more pieces of firing information, which will be described later, and state determination information, which will be described later, and various kinds of conditions.

The start point storage unit 111 stores one or more pieces of firing start point information. The start point storage unit 111 typically stores two or more pieces of firing start point information. The pieces of firing start point information are associated with the initial firing condition.

Firing start point information is information that specifies the node that fires at the first stage when information is accepted. The information to be accepted is, for example, one or more kinds of information of image information and sound information. The node that fires in the first stage is a node that fires without going through another node. The firing start point information contains, for example, an initial firing condition and one or more node identifiers.

The initial firing condition is a condition for a node to fire in the first stage. Note that the initial firing condition is a condition related to one or more pieces of feature information. The one or more pieces of feature information are one or more kinds of information of one or more pieces of image feature information for image information; and one or more pieces of sound feature information for sound information. The initial firing condition may also be, for example, a condition related to one or more information identifiers. The initial firing condition contains, for example, an information identifier. The initial firing condition is, for example, a condition related to an information identifier and an information amount.

The information identifier is information that identifies feature information. The information identifier is, for example, information that identifies image feature information. The information identifier is, for example, information that specifies the type of image feature information. The information identifier is, for example, information that identifies sound feature information. The information identifier indicates, for example, “R”, “G”, or “B”. “R” is information indicating the color red, “G” is information indicating the color green, and “B” is information indicating the color blue. Note that image feature information is feature information of image information. The information identifier is, for example, information indicating a specific frequency or information indicating a specific frequency range.

The initial firing condition is, for example, “<information identifier> R <condition> information amount>=150”. The initial firing condition is, for example, “information amount of “R”>=150”, “(information amount of “R”>=150) & (information amount of “G”>=80)”, “(information amount of “R”>=150) & (information amount of “G”>=80) & (information amount of “B”>=120)”, “<information identifier> frequency=Fa <condition> information amount>=100”, “<information identifier> Fa<=frequency <Fb <condition> information amount>=100”, or “<information identifier> R <condition> information amount >=150 & <information identifier> frequency=Fa <condition> information amount>=180”. Note that the frequencies Fa and Fb are values indicating specific frequencies.

Each node identifier is, for example, information that identifies a node that is included in the NN. Each node identifier is, for example, a node ID or a node name. Each node may be referred to as a soma. Node identifiers may be referred to as soma identifiers.

The feature information here is a feature of image information or sound information. The feature information is, for example, an information identifier, or an information identifier and an information amount. The information amount is information that indicates the size of the information identified by the information identifier paired therewith. The feature information is, for example, “<information identifier> R <information amount> 150”, “<information identifier> frequency=Fa <information amount> 100”, or “<information identifier> Fa<=frequency <Fb <information amount>=150”.

The goal storage unit 112 stores one or more pieces of goal information. The goal storage unit 112 typically stores two or more pieces of goal information.

The goal information is information that specifies the goal to which a node or an edge included in the NN grows. The goal information is information that specifies a goal corresponding to one state of two or more states. The state is, for example, an emotion or an internal state of the brain. The state is, for example, positive or negative. It is preferable that each type of state is either positive or negative. However, there may be three or more types of states. If there are three or more types of states, each state is, for example, information indicating any one of two or more degrees of positive state, or information indicating any one of two or more degrees of negative state, or positive, negative, or neutral.

The goal information can be said to be information that specifies a position to which a node or edge will grow. The goal information contains goal position information or goal direction information. The goal information corresponds to a state identifier. The goal position information is information that specifies the position of the goal. The goal direction information indicates the direction of the goal. The position is a position in a virtual space of two or more dimensions. The goal information is, for example, position information. The position information is, for example, three-dimensional coordinate values (x, y, z), two-dimensional coordinate values (x, y), or a four-dimensional quaternion (x, y, x, w). In addition, the fact that the goal information corresponds to the state identifier means that the goal information corresponding to the determined state identifier is used for the growth of the NN. Note that the state identifier is information that identifies the state. The state identifier is, for example, “positive” or “negative”.

The reference score storage unit 113 stores one or more reference scores. Each of the one or more reference scores is, for example, paired with a firing pattern. However, when only one reference score is stored in the reference score storage unit 113, the reference score is not paired with a firing pattern. The reference score storage unit 113 may store one default reference score.

The reference score is a score that serves as a reference used to determine the state such as a positive state or a negative state. The score is information indicating the degree of the state, such as a positive state or a negative state. The reference score may also be referred to as an expected value.

The firing pattern is a pattern of firing of one or more nodes. The firing pattern contains node identifier(s) of one or more firing nodes.

The NN storage unit 114 stores neural network information (hereinafter referred to as “NN information” where appropriate). The NN information can be said to be information that mimics the brain. The NN information contains two or more pieces of node information and one or more pieces of edge information. NN information may also be referred to as “NN”.

The node information is information regarding the nodes included in the NN. The node information contains a node identifier. The node information contains, for example, node position information, a firing condition, firing probability information, and count information. It is also preferable that the node information contains information necessary energy amount information that indicates the amount of energy necessary for firing.

The node position information is position information regarding a node. As described above, the position information is, for example, three-dimensional coordinate values (x, y, z), two-dimensional coordinate values (x, y), or a four-dimensional quaternion (x, y, x, w).

The firing condition is a condition for a node to fire. The firing condition typically includes one or more pieces of feature information. The feature information may be information that includes an information identifier that identifies information and an information amount that indicates the size of the information, or may be information that only includes an information amount that indicates the size of the information. The information amount is, for example, a numerical value greater than zero. The firing condition is, for example, “R>=180”, “R>150 & G>=100”, “G<=50 & B<=30”, “R>=250 & G>=250 & B>=250”, “<information identifier> frequency=Fa <condition> information amount>=80”, “<information identifier> Fa<=frequency <Fb <condition> information amount>=150”, “<information identifier> R <condition> information amount>=150 & <information identifier> frequency=Fa <condition> information amount>=180”, or the like.

The firing probability information is information regarding the probability of firing. The firing probability information may be the firing probability itself, or may be a value obtained by converting the firing probability using a function or the like. It is preferable that the firing probability information is referenced, and the node may or may not fire at the probability indicated by the firing probability information even if the feature information is the same.

The count information is information based on the number of times the node has fired. The count information is, for example, the number of firings or the frequency of firings (firing rate).

The edge information is information regarding edges included in the NN. The edge information is information that specifies connections between nodes. Each piece of edge information typically contains an edge identifier. Each piece of edge information contains, for example, the node identifiers of the two nodes that the edge connects. Each piece of edge information contains, for example, one node identifier of a node to which the edge connects. If a piece of edge information contains only one node identifier, the edge is a growing edge before connecting two nodes. Each piece of edge information contains, for example, edge position information. The edge position information is information that specifies the position of an end point of the edge. Each piece of edge information contains, for example, a weight. The larger the value of the weight of an edge is, the easier it is for feature information to be transmitted through that edge. The weight of an edge may be a parameter of firing probability information. That is to say, the greater the weight of an edge is, the greater the firing probability may be. It is preferable that each piece of edge information contains retained energy amount information that indicates the amount of energy stored in the edge.

Each piece of edge information contains, for example, dendrite information and axon information. In such a case, each edge contains a dendrite and an axon. Note that each edge may be considered to be a single line, or a line having two or more branches. Note that edges may be referred to as synapses.

Each edge identifier is information that identifies the edge. Each edge identifier is, for example, an edge ID or an edge name.

The dendrite information is information regarding dendrites. Dendrites are parts of nerve cells. Dendrites are multiple projections that branch out from a cell body like the branches of a tree to receive external stimuli and information sent out by the axons of other neurons. The dendrites here are elements that are included in the edges. Each piece of dendrite information contains a dendrite identifier and dendrite position information.

Each dendrite identifier is information that identifies a dendrite. Each dendrite identifier is, for example, a dendrite ID or a dendrite name.

The dendrite position information is information regarding the positions of the dendrites. The dendrite position information is information that specifies the positions of the dendrites, and is, for example, one or more sets of three-dimensional coordinate values (x, y, z) or one or more sets of two-dimensional coordinate values (x, y). When a piece of dendrite position information contains two or more sets of coordinate values, the dendrite is a line connecting the points indicated by the two or more coordinate values.

It is preferable that each piece of dendrite information contains retained energy amount information that indicates the amount of energy stored in the dendrite. It is also preferable that each piece of dendrite information contains necessary energy amount information that indicates the amount of energy required to transfer information using the dendrite.

Axon information is information regarding axons. Axons are protrusion structures extending from a cell body and are responsible for outputting signals in nerve cells. The axons here are elements that are included in the edges. Each piece of axon information contains an axon identifier and axon position information.

Each axon identifier is information that identifies an axon. Each axon identifier is, for example, an axon ID or an AXON name.

Each axon position information is position information indicating the position of the axon. The axon position information is information that specifies the positions of the axons, and is, for example, one or more sets of three-dimensional coordinate values (x, y, z) or one or more sets of two-dimensional coordinate values (x, y). When a piece of axon position information contains two or more sets of coordinate values, the axon is a line connecting the points indicated by the two or more coordinate values.

It is preferable that each piece of axon information contains retained energy amount information that indicates the amount of energy stored in the axon. It is also preferable that each piece of axon information contains necessary energy amount information that indicates the amount of energy required to transfer information using the axon.

Note that dendrites and axons may be branched. When dendrites and axons are branched, the position information of each can be expressed by three or more sets of coordinate values. However, there is no limitation on the method of expressing dendrite position information and axon position information.

The glial cell information stored in the storage unit 11 is information regarding glial cells. Note that the glial cell information does not have to be stored in the storage unit 11.

Here, glial cells are also called neuroglial cells, which is a general term for non-neuronal cells that are included in the nervous system. Glial cells are a glue- or cement-like substance that fills the spaces between neurons.

It is preferable that each piece of glial cell information contains a glial cell identifier that identifies the glial cell. Each piece of glial cell information may contain, for example, a node identifier that identifies a node that supports the connection, or an edge identifier that identifies an edge that supports the connection. Each piece of glial cell information may contain, for example, an axon identifier of an axon whose connection is assisted by the glial cell, or a dendrite identifier of a dendrite whose connection is assisted by the glial cell. Each piece of glial cell information may also contain a glial cell type identifier that identifies the type of glial cell. Types of glial cells include, for example, an oligodendrocite (hereinafter referred to as an “oligo” when appropriate) and an astrocite. Note that an oligo is a cell that can be connected to an axon. An astrocite is a cell that can be connected to a soma or a dendrite. It is preferable that each piece of glial cell information contains glial cell position information. The glial cell position information is position information that specifies the position of the glial cell. In particular, it is preferable that glial cell information of an oligo contains glial cell position information. In addition, each piece of glial cell information may also contain hand length information indicating the length of each of one or more hands. In addition, each piece of glial cell information may contain hand number information indicating the number of hands extending from the glial cell. Typically, it is preferable that a glial cell does not grow any further when the total hand length of the glial cell calculated from the hand length information of each hand reaches a threshold value.

Each piece of connection information stored in the storage unit 11 is information that specifies a connection between two or more nodes. Each piece of connection information may be information that specifies a connection between an axon of one node and a dendrite of another node. Such information is also information that specifies connections between nodes. Each piece of connection information may be information that specifies a connection between one synapse and one spine. Such information is also information that specifies connections between nodes. Each piece of connection information contains, for example, node identifiers of two nodes that are connected. In addition, each piece of connection information contains, for example, the axon identifier of an axon and the dendrite identifier of a dendrite that is connected to the axon. In addition, each piece of connection information contains, for example, the synapse identifier of a synapse and the spine identifier of a spine that can transfer information to and from the synapse. Each piece of connection information may contain information transfer probability information. The information transfer probability information is information regarding the probability of information transfer between one node and another node. The information transfer probability information may be information regarding the probability of information transfer between an axon and a dendrite. Even in such a case, the information transfer probability information is information regarding the probability of information transfer between one node and another node. In addition, the information transfer probability information may be information regarding the probability of information transfer between a synapse and a spine. Even in such a case, the information transfer probability information is information regarding the probability of information transfer between one node and another node. Note that the connection direction between nodes here is typically unidirectional.

Each piece of connection information may be information indicating a connection between a node and an axon. In such a case, each piece of connection information contains a node identifier and an axon identifier. In addition, each piece of connection information may be information indicating the connection between a node and a dendrite. In such a case, each piece of connection information contains a node identifier and a dendrite identifier.

Each piece of connection information may be information that specifies a connection between a glial cell an axon or a dendrite. In such a case, each piece of connection information contain, for example, a glial cell identifier that identifies glial cell information and an axon identifier. Each piece of connection information may contain, for example, a glial cell identifier and a dendrite identifier.

Note that the connection information that specifies connections between the elements (nodes, edges, axons, dendrites, glial cells, synapses, or spines) included in the NN may be stored in the NN storage unit 114. That is to say, the connection information that specifies connections between the elements included in the NN may be contained in information regarding each element.

The firing information is information regarding the result of firing. The firing information contains a node identifier that identifies the node that has fired. The firing information may typically contain timer information indicating when firing occurred. The timer information may be information indicating a relative time, or time information indicating an absolute time. Note that the firing information may be automatically deleted by the processing unit 13 when a certain period of time has elapsed since its accumulation.

The state determination information is information for determining one state using one or more kinds of information of image information and sound information. The state determination information is, for example, a condition that is based on difference information, which will be described later. The state determination information is, for example, two or more sets each containing an image condition, which is a condition related to the image information, and a state identifier. The state determination information is, for example, two or more sets each containing a sound condition, which is a condition related to the sound information, and a state identifier. The state determination information is, for example, two or more sets each containing an image sound condition, which is a condition related to the image information and the sound information, and a state identifier.

The state determination information is, for example, “difference information>=threshold A <state identifier> state P” or “difference information <threshold B <state identifier> state N”, and the state determination information is, for example, “<image condition> information amount of R>=150 <state identifier> state P”, “<image condition> (information amount of “R”<=10) & (information amount of “G”<=80) <state identifier> state N”, “<sound condition> information amount of information identifier “frequency=X”>=50 <state identifier> state P”, “<sound condition> information amount of information identifier “frequency=X”>=80 <state identifier>state N”, “<sound condition> information amount of information identifier “frequency=Y”>=50 & information amount of information identifier “frequency=Z”>=90 <state identifier> state P”, or “<image sound condition> information amount of R>=150 & information amount of information identifier “frequency=Y”>=50 <state identifier> state P”. Note that the state P has a state identifier “positive” and the state N has a state identifier “negative”.

The acceptance unit 12 accepts various kinds of information. Example of the various kinds of information include image information and sound information.

The “acceptance” here is a concept that includes, for example, acceptance of information input from an input device such as a camera, reception of information transmitted via a wired or wireless communication network, or acceptance of information read out from a recording medium such as an optical disk, a magnetic disk, or a semiconductor memory.

The information acceptance unit 121 accepts information. The information acceptance unit 121 accepts, for example, one or two kinds of information of image information and sound information. The information acceptance unit 121 accepts, for example, image information and sound information at the same time. However, for example, there may be some delay in the reception of image information and sound information by the information acceptance unit 121. The image information is a still image or a moving image. The sound information is, for example, voice data or music data, but the sound information need only be information regarding sound, and there is no limitation on the type thereof.

The information acceptance unit 121 acquires, for example, image information acquired by a camera. The information acceptance unit 121 acquires, for example, sound information acquired by a microphone. That is to say, the “acceptance” is acceptance of information acquired by a device such as a microphone or a camera, but may be a concept that includes reception of information transmitted via a wired or wireless communication network, acceptance of information read out from a recording medium such as an optical disk, a magnetic disk, or a semiconductor memory, and so on.

The processing unit 13 performs various kinds of processing. Examples of the various kinds of processing include processing performed by the image feature acquisition unit 131, processing performed by the sound feature acquisition unit 132, processing performed by the growth unit 138, and so on.

The image feature acquisition unit 131 uses the image information accepted by the information acceptance unit 121 to acquire one or more pieces of image feature information corresponding to the image information.

The sound feature acquisition unit 132 uses the sound information accepted by the information acceptance unit 121 to acquire one or more pieces of sound feature information corresponding to the sound information.

The image score acquisition unit 133 uses the one or more pieces of image feature information acquired by the image feature acquisition unit 131 to acquire an image score.

The image score is a score for the accepted image information. The image score is typically a score related to a positive state or a negative state. The image score is, for example, information indicating a positive degree or information indicating a negative degree.

The image score acquisition unit 133 acquires the image score by, for example, one of the following three methods.

### (1) Method Using Calculation Formula

The image score acquisition unit 133 substitutes the information amount contained in each of the one or more pieces of image feature information acquired by the image feature acquisition unit 131 into an image calculation formula, and executes the image calculation formula to calculate an image score. Note that the image calculation formula is a formula that uses the information amount contained in each of one or more pieces of image feature information as a parameter. The image calculation formula is stored in the storage unit 11.

### (2) Method Using Correspondence Table

The image score acquisition unit 133 acquires from the image correspondence table an image score that is paired with a vector that is most similar to a vector whose elements are the information amount(s) contained in the one or more pieces of image feature information acquired by the image feature acquisition unit 131. The image correspondence table is a table showing the correspondence between the set of one or more pieces of image feature information and image scores. The image correspondence table contains two or more pieces of image correspondence information. Each piece of image correspondence information is information indicating the correspondence between a vector whose elements are the information amount(s) contained in the one or more pieces of image feature information, and an image score. The image correspondence information is, for example, a set of a vector and an image score.

### (3) Method Using Machine Learning

The image score acquisition unit 133 provides a vector whose elements are the information amount(s) contained in one or more pieces of image feature information acquired by the image feature acquisition unit 131 and an image learning model to a machine learning prediction module, and executes the prediction module to acquire an image score.

Note that the image learning model is information acquired by providing two or more pieces of training data having a vector whose elements are the information amount(s) contained in one or more pieces of image feature information and an image score to a machine learning module and executing the learning module. The image learning model is stored in the storage unit 11.

The sound score acquisition unit 134 acquires a sound score using one or more pieces of sound feature information acquired by the sound feature acquisition unit 132.

The sound score is the score for the accepted sound information. The sound score is typically a score related to a positive state or a negative state. The sound score is, for example, information indicating a positive degree or information indicating a negative degree.

The sound score acquisition unit 134 acquires the sound score by, for example, one of the following three methods.

### (1) Method Using Calculation Formula

The sound score acquisition unit 134 substitutes the information amount contained in each of the one or more pieces of sound feature information acquired by the sound feature acquisition unit 132 into a sound calculation formula, and executes the sound calculation formula to calculate a sound score. Note that the sound calculation formula is a formula that uses the information amount contained in each of one or more pieces of sound feature information as a parameter. The sound calculation formula is stored in the storage unit 11.

### (2) Method Using Correspondence Table

The sound score acquisition unit 134 acquires from the sound correspondence table a sound score that is paired with a vector that is most similar to a vector whose elements are the information amount(s) contained in the one or more pieces of sound feature information acquired by the sound feature acquisition unit 132. The sound correspondence table is a table showing the correspondence between the set of one or more pieces of sound feature information and sound scores. The sound correspondence table contains two or more pieces of sound correspondence information. Each piece of sound correspondence information is information indicating the correspondence between a vector whose elements are the information amount(s) contained in the one or more pieces of sound feature information, and a sound score. The sound correspondence information is, for example, a set of a vector and a sound score.

### (3) Method Using Machine Learning

The sound score acquisition unit 134 provides a vector whose elements are the information amount(s) contained in one or more pieces of sound feature information acquired by the sound feature acquisition unit 132 and a sound learning model to a machine learning prediction module, and executes the prediction module to acquire a sound score.

Note that the sound learning model is information acquired by providing two or more pieces of training data having a vector whose elements are the information amount(s) contained in one or more pieces of sound feature information and a sound score to a machine learning module and executing the learning module. The sound learning model is stored in the storage unit 11.

Learning models such as the image learning model, the sound learning model, and the comprehensive learning model described below are information formed through machine learning processing, and are information used for machine learning prediction processing. The learning models may also be referred to as a learner, a classifier, a classification model, or the like. The above machine learning algorithms can be any algorithm, such as deep learning, random forest, decision tree, SVR, or the like. In addition, for machine learning, for example, the TensorFlow library, the R language random forest module, various machine learning functions such as fastText and TinySVM, or various existing libraries can be used.

The overall score acquisition unit 135 acquires an overall score that is based on one or more pieces of image feature information and one or more pieces of sound feature information.

For example, the overall score acquisition unit 135 acquires the overall score using the image score and the sound score. The overall score acquisition unit 135 acquires a larger overall score for a larger image score. The overall score acquisition unit 135 acquires a larger overall score for a larger sound score. For example, the overall score acquisition unit 135 uses an increasing function having the image score and the sound score as parameters to acquire the overall score. For example, the overall score acquisition unit 135 acquires the overall score that is the sum of the image score and the sound score. For example, the overall score acquisition unit 135 acquires the overall score that is an average value of the image score and the sound score. For example, the overall score acquisition unit 135 acquires the overall score that is a weighted average value of the image score and the sound score.

The overall score acquisition unit 135 may acquire the overall score without using the image score or the sound score. In such a case, the overall score acquisition unit 135 acquires the sound score by, for example, one of the following three methods.

### (1) Method Using Calculation Formula

The overall score acquisition unit 135 substitutes one or more information amounts of: the information amount contained in the one or more pieces of image feature information acquired by the image feature acquisition unit 131; and the information amount contained in one or more pieces of sound feature information acquired by the sound feature acquisition unit 132, into an overall calculation formula, and executes the overall calculation formula to calculate an overall score. Note that the overall calculation formula is a formula that uses the information amount contained in each of one or more pieces of feature information as a parameter. The overall calculation formula is stored in the storage unit 11.

### (2) Method Using Correspondence Table

The overall score acquisition unit 135 acquires from the overall correspondence table an overall score that is paired with a vector that is most similar to a vector whose elements are one or more information amounts of: the information amount(s) contained in the one or more pieces of image feature information acquired by the image feature acquisition unit 131; and the information amount(s) contained in the one or more pieces of sound feature information acquired by the sound feature acquisition unit 132. The overall correspondence table is a table showing the correspondence between the set of one or more pieces of feature information and overall scores. The overall correspondence table contains two or more pieces of overall correspondence information. Each piece of overall correspondence information is information indicating the correspondence between a vector whose elements are the information amount(s) contained in the one or more pieces of feature information, and an overall score. The overall correspondence information is, for example, a set of a vector and an overall score.

### (3) Method Using Machine Learning

The overall score acquisition unit 135 provides a vector whose elements are one or more pieces of information amounts of the information amount(s) contained in one or more pieces of image feature information acquired by the image feature acquisition unit 131; and the information amount(s) contained in one or more pieces of sound feature information acquired by the sound feature acquisition unit 132, and an overall learning model, to a machine learning prediction module, and executes the prediction module to acquire an overall score.

Note that the overall learning model is information acquired by providing two or more pieces of training data having a vector whose elements are the information amount(s) contained in one or more pieces of feature information and an overall score to a machine learning module and executing the learning module. The overall learning model is stored in the storage unit 11.

The firing node determination unit 136 determines, from among the node identifiers stored in the start point storage unit 111, one or more node identifiers that are paired with an initial firing condition that matches one or two types of information of: one or more pieces of image feature information; and one or more pieces of sound feature information.

Next, the firing node determination unit 136 determines the node identifier of a node that is connected to each of the one or more firing nodes by edges to receive one or more pieces of feature information from the firing node, and that is to fire. Note that the node identifiers of the firing nodes are referred to as the firing node identifiers where appropriate. The one or more pieces of feature information are one or two types of information of: one or more pieces of image feature information; and one or more pieces of sound feature information.

The firing node determination unit 136 determines the node identifier of a node that is connected by an edge whose weight satisfies a transfer condition. The transfer condition is a condition for transferring feature information from one node to another node connected to the node by an edge. The transfer condition is a condition regarding a weight. The transfer condition is, for example, “weight>=threshold value” or “weight>threshold value”.

For example, the firing node determination unit 136 determines whether or not one or more pieces of feature information passed from one or more other nodes connected by an edge satisfy the firing condition related to one or more pieces of feature information, and determines the node identifier of the node determined to satisfy the firing condition. Note that the firing condition is a condition related to one or more pieces of feature information.

It is preferable that the firing node determination unit 136 accumulates count information related to the count of the determined node identifiers in association with the node identifiers. That is to say, it is preferable that the firing node determination unit 136 increase the count information of the node that has fired.

The state determination unit 137 determines one state from two or more states, including a positive state and a negative state, using difference information. Note that the two or more states are, for example, “positive” and “negative”, or “positive”, “negative”, and “neutral”.

The difference information is information regarding the difference between an overall score and a reference score. Difference information refers to, for example, “overall score−reference score”, “the absolute value of the difference between overall score and reference score”, “overall score/reference score”, or “reference score/overall score”.

For example, the state determination unit 137 acquires difference information indicating the difference between the overall score acquired by the overall score acquisition unit 135 and the reference score. Next, the state determination unit 137 acquires a state identifier corresponding to the difference information. Note that the difference information may also be information acquired by the growth unit 138, which will be described later.

For example, the state determination unit 137 acquires the overall score acquired by the overall score acquisition unit 135. The state determination unit 137 determines, from the reference score storage unit 113, a firing pattern that matches one or more node identifiers determined by the firing node determination unit 136, and acquires the reference score paired with the firing pattern from the reference score storage unit 113. Next, the state determination unit 137 acquires difference information between the overall score and the reference score. Next, the state determination unit 137 acquires a state identifier corresponding to the difference information.

For example, the state determination unit 137 determines the state as “positive” when “overall score−reference score (difference information)>=threshold value A”. For example, the state determination unit 137 determines the state as “negative” when “overall score−reference score<threshold value B”. For example, the state determination unit 137 determines the state as “neutral” when “threshold B<=overall score−reference score<threshold A”.

The growth unit 138 performs growth processing. The growth unit 138 performs growth processing for growing an NN that mimics the brain. The growth unit 138 performs NN growth processing using the accepted image information and sound information. The growth unit 138 performs processing to grow the nodes or edges, or the nodes and edges, which are to be included in the NN, using one or more pieces of image feature information acquired from the accepted image information and one or more pieces of sound feature information acquired from the sound information.

More specifically, the growth unit 138 acquires difference information regarding the difference between the overall score and the reference score, and performs growth processing based on the difference information. The growth unit 138 performs growth processing when the difference information matches the growth condition.

The growth unit 138 acquires the reference score paired with the firing pattern corresponding to one or more node identifiers determined by the firing node determination unit 136 from the reference score storage unit 113. Next, the growth unit 138 acquires difference information related to the difference between the acquired overall score and the reference score, and performs growth processing based on the difference information.

Examples of the growth processing include edge generation processing, edge growth processing, and node generation processing. Examples of the edge growth processing include first edge growth processing and second edge growth processing. Hereinafter, each type of processing will be described.

### (1) Edge Growth Processing

The growth unit 138 performs, for example, edge growth processing. The edge growth processing is processing performed to grow an edge. For example, the processing performed to grow an edge is processing performed to increase the weight of the edge. Increasing the weight of an edge means making the edge thicker. For example, the processing performed to grow an edge is processing performed to lengthen the edge. The processing performed to grow an edge may be processing performed to connect the edge from the node from which the edge originates to another node.

### (1-1) First Edge Growth Processing

The growth unit 138 acquires difference information regarding the difference between the overall score and the reference score, and when that difference information matches the first edge growth condition, the growth unit 138 performs the first edge growth processing to increase the weight of the edge information of each of the one or more edges connected to the fired node.

The first edge growth condition is a condition for changing the weight of an edge. For example, the first edge growth condition is “difference information <=threshold value” or “difference information<threshold value”. That is to say, typically, the growth unit 138 increases the weight of an edge when the difference between the overall score and the reference score is small. The first edge growth condition may contain degree information indicating the extent of the weight to be changed. For example, the first edge growth condition is “if (difference information<=threshold value) then weight +5” or “if (difference information<threshold value) then weight +3”. Note that “weight +5” indicates increasing the weight by “3”.

### (1-2) Second Edge Growth Processing

The growth unit 138 acquires difference information regarding the difference between the overall score and the reference score, and when the difference information matches the second edge growth condition, the growth unit 138 performs the second edge growth processing to change the edge position information contained in the edge information of each of the one or more edges connected to the node identified by one or more node identifiers determined by the firing node determination unit 136, thereby increasing the length of each edge.

The second edge growth condition refers to a condition for extending the length of an edge. For example, the second edge growth condition is a condition based on difference information or a condition based on count information. For example, the second edge growth condition is “difference information>=threshold value”, “difference information>threshold value”, “count information >=threshold value”, or “count information>threshold value”. Typically, when the difference between the overall score and the reference score is large, the growth unit 138 increases the length of an edge connected to the fired node but not connected to other nodes.

Note that, for example, the growth unit 138 acquires goal information paired with the state identifier (e.g., “positive” or “negative”) of the one state determined by the state determination unit 137. Next, for example, the growth unit 138 acquires edge position information contained in the edge information of each of the one or more edges, acquires new edge position information in the direction indicated by the goal information relative to the edge position information, and performs the second edge growth processing to accumulate the new edge position information.

Note that, for example, the target of the second edge growth processing is an edge connected to one or more nodes determined by the firing node determination unit 136. For example, the target of the second edge growth processing may be a portion of edges that match a specific condition among the one or more nodes determined by the firing node determination unit 136. For example, the specific condition is a condition based on weight. For example, the specific condition is “weight is equal to or greater than a threshold value” or “weight is greater than a threshold value”.

Note that the second edge growth processing may be one or more of dendrite growth processing, which will be described later, and axon growth processing, which will be described later.

### (1-3) Dendrite Growth Processing

The growth unit 138 performs, for example, dendrite growth processing. The dendrite growth processing is processing performed to grow a dendrite. The dendrite growth processing may be included in edge growth processing. The processing performed to grow a dendrite is typically processing performed to increase the length of the dendrite. The processing performed to grow a dendrite is processing performed to acquire new dendrite position information in which the position of the end point indicated by the dendrite position information contained in the dendrite information of the dendrite is away from the position of the connected node, and to accumulate the new dendrite position information.

For example, the growth unit 138 performs dendrite growth processing to generate and accumulate dendrite information in which a dendrite is grown, the dendrite extending from one or more nodes identified by one or more node identifiers of the one or more node identifiers determined by the firing node determination unit 136 in a direction indicated by the goal information that is paired with the one state determined by the state determination unit 137.

It is preferable that the one or more node identifiers of the one or more node identifiers determined by the firing node determination unit 136 are the node identifiers of one or more nodes that match the dendrite growth condition of the one or more node identifiers determined by the firing node determination unit 136. However, one or more node identifiers of the one or more node identifiers determined by the firing node determination unit 136 may be all of the node identifiers determined by the firing node determination unit 136.

Note that acquiring dendrite information in which a dendrite extending from a node is grown means changing the dendrite position information contained in the dendrite information to position information in which the end point of the dendrite indicated by the dendrite position information is located further away from the node.

The dendrite growth condition is a condition for performing dendrite growth processing. The dendrite growth condition is, for example, a condition based on difference information, or a condition based on count information. For example, the dendrite growth condition is “difference information>=threshold value”, “difference information>threshold value”, “count information>=threshold value”, or “count information>threshold value”. The dendrite growth condition may be the same as or different from the second edge growth condition.

In addition, the processing performed to grow a dendrite extending from a node is processing performed to further acquire position information that specifies a position in the direction indicated by the goal information from the dendrite position information contained in the dendrite information that is paired with the node identifier that identifies the node, and to set the position information as the dendrite position information.

### (1-4) Axon Growth Processing

The growth unit 138 performs, for example, axon growth processing. The axon growth processing is processing performed to grow an axon. The axon growth processing may be included in the edge growth processing. The processing performed to grow an axon is typically processing performed to increase the length of the axon. The processing performed to grow an axon is processing performed to acquire new axon position information in which the position of the end point indicated by the axon position information contained in the axon information of the axon is away from the position of the connected node, and to accumulate the new axon position information.

For example, the growth unit 138 performs axon growth processing to acquire and accumulate axon information in which an axon is grown, the axon extending from one or more nodes identified by one or more node identifiers among the one or more node identifiers determined by the firing node determination unit 136 in a direction indicated by the goal information that is paired with the one state determined by the state determination unit 137.

It is preferable that the one or more node identifiers of the one or more node identifiers determined by the firing node determination unit 136 are the node identifiers of one or more nodes that match the axon growth condition of the one or more node identifiers determined by the firing node determination unit 136. However, one or more node identifiers of the one or more node identifiers determined by the firing node determination unit 136 may be all of the node identifiers determined by the firing node determination unit 136.

Note that acquiring axon information in which an axon extending from a node is grown means changing the axon position information contained in the axon information to position information in which the end point of the axon indicated by the axon position information is located further away from the node.

The axon growth condition is a condition for performing axon growth processing. The axon growth condition is, for example, a condition based on difference information or count information. For example, the axon growth condition is “difference information>=threshold value”, “difference information >threshold value”, “count information>=threshold value”, or “count information>threshold value”. The axon generation condition may be the same as or different from the second edge growth condition.

In addition, the processing performed to grow an axon extending from a node is processing performed to further acquire position information that specifies a position in the direction indicated by the goal information from the axon position information contained in the axon information that is paired with the node identifier that identifies the node, and to set the position information as the axon position information.

### (2) Edge Generation Processing

The growth unit 138 performs, for example, edge growth processing. The edge generation processing can be said to be processing performed to generate new edges. The edge generation processing is processing performed to generate new edge information and accumulate it in the NN storage unit 114.

The growth unit 138 acquires difference information regarding the difference between the overall score and the reference score, and based on the difference information, generates and accumulates edge information for edges extending from one or more nodes identified by one or more node identifiers among the one or more node identifiers determined by the firing node determination unit 136, in the direction indicated by the goal information paired with the one state determined by the state determination unit 137.

For example, the growth unit 138 performs edge generation processing on a node identified by a node identifier when the edge generation condition is satisfied.

The edge generation condition is a condition for generating edge information. The edge generation condition is, for example, a condition based on difference information. The edge generation condition may be a condition based on count information. For example, the edge generation condition is “difference information>=threshold value”, “difference information>threshold value”, “count information>=threshold value”, or “count information>threshold value”. In addition, the edge generation condition may be common to all nodes of interest, may be different for each node, or may be different for each edge. When the edge generation condition is different for each node, the node information contains the edge generation condition, for example. When the edge generation condition is different for each edge, the edge information contains the edge generation condition, for example.

The growth unit 138 generates and accumulates edge information for edges extending from one or more nodes identified by one or more node identifiers among the node identifiers determined by the firing node determination unit 136, at the position in the direction indicated by the goal information paired with the one state determined by the state determination unit 137.

It is preferable that the one or more node identifiers of the one or more node identifiers determined by the firing node determination unit 136 are one or more node identifiers that match the edge generation condition of the one or more node identifiers determined by the firing node determination unit 136. However, one or more node identifiers of the one or more node identifiers determined by the firing node determination unit 136 may be all of the node identifiers determined by the firing node determination unit 136.

Note that the processing performed to generate edge information is processing performed to generate edge information regarding an edge connected to a node identified by a target node identifier. The processing performed to generate edge information is, for example, processing performed to acquire a unique edge identifier, and generate edge information that contains an edge identifier, which is information regarding an edge that connects a node identified by the target node identifier to another node in the direction indicated by the goal information from the node. Such edge information contains, for example, the node identifiers of the two nodes that are to be connected to the edge identifier. The processing performed to generate edge information is, for example, processing performed to acquire a unique edge identifier, acquire edge position information that specifies the position of the end point of the edge extending from the node identified by the target node identifier in the direction from the node indicated by the goal information, and generate edge information that contains the edge position information. Such edge information contains, for example, an edge identifier, a node identifier of a target (connecting) node, and edge position information that specifies the position of the end point of the edge.

Note that the edge generation processing may be one or more of dendrite generation processing, which will be described later, and axon generation processing, which will be described later. In addition, the edge generation processing may include glial cell generation processing, which will be described later.

### (2-1) Dendrite Generation Processing

The growth unit 138 performs, for example, dendrite generation processing. The dendrite generation processing is processing performed to generate a new dendrite. The dendrite generation processing may include processing performed to generate new dendrite information and accumulate it in the NN storage unit 114. That is to say, for example, the growth unit 138 generates and accumulates dendrite information for a dendrite, the dendrite extending from one or more nodes identified by one or more node identifiers of the one or more node identifiers determined by the firing node determination unit 136 in a direction indicated by the goal information that is paired with the one state determined by the state determination unit 137.

It is preferable that the one or more node identifiers of the one or more node identifiers determined by the firing node determination unit 136 are one or more node identifiers that match the dendrite generation condition of the one or more node identifiers determined by the firing node determination unit 136. However, one or more node identifiers of the one or more node identifiers determined by the firing node determination unit 136 may be all of the node identifiers determined by the firing node determination unit 136.

Note that the processing performed to generate dendrite information is processing performed to generate dendrite information regarding the dendrite connected to the node identified by the target node identifier. The processing performed to generate dendrite information is, for example, processing performed to acquire a unique dendrite identifier, acquire dendrite position information that specifies the dendrite extending from the node identified by the target node identifier (the node identifier of the node to which the dendrite is connected) in the direction indicated by the goal information, and form and accumulate dendrite information that contains the dendrite identifier and the dendrite position information.

The dendrite generation condition is a condition for generating a dendrite. The dendrite generation condition is, for example, a condition based on difference information or count information. For example, the dendrite generation condition is “difference information>=threshold value”, “difference information>threshold value”, “count information>=threshold value”, or “count information>threshold value”. The dendrite generation condition may be the same as or different from the edge generation condition.

### (2-2) Axon Generation Processing

The growth unit 138 performs, for example, axon generation processing. The axon generation processing is processing performed to generate a new axon. The axon generation processing may include processing performed to generate new axon information and accumulate it in the NN storage unit 114. That is to say, for example, the growth unit 138 generates and accumulates axon information for an axon, the axon extending from one or more nodes identified by one or more node identifiers of the one or more node identifiers determined by the firing node determination unit 136 in a direction indicated by the goal information that is paired with the one state determined by the state determination unit 137.

It is preferable that the one or more node identifiers of the one or more node identifiers determined by the firing node determination unit 136 are one or more node identifiers that match the axon generation condition of the one or more node identifiers determined by the firing node determination unit 136. However, one or more node identifiers of the one or more node identifiers determined by the firing node determination unit 136 may be all of the node identifiers determined by the firing node determination unit 136.

Note that the processing performed to generate axon information is processing performed to generate axon information regarding the axon connected to the node identified by the target node identifier (the node identifier of the node to which the axon is connected). The processing performed to generate axon information is, for example, processing performed to acquire a unique axon identifier, acquire axon position information that specifies the position of the axon extending from the node identified by the target node identifier in the direction indicated by the goal information, and form and accumulate axon information that contains the axon identifier and the axon position information.

The axon generation condition is a condition for generating an axon. The axon generation condition is, for example, a condition based on difference information or count information. For example, the axon generation condition is “difference information>=threshold value”, “difference information threshold value”, “count information>=threshold value”, or “count information >threshold value”. The axon generation condition may be the same as or different from the edge generation condition.

### (3) Node Generation Processing

The growth unit 138 performs, for example, node generation processing. The node generation processing is processing performed to generate new node information. That is to say, the growth unit 138 performs node generation processing to generate and accumulate node information regarding a new node at a position in the direction indicated by the goal information that is paired with the one state determined by the state determination unit 137 and in the vicinity of the position indicated by node position information of one or more nodes identified by one or more node identifiers of the one or more node identifiers acquired by the firing node determination unit 136, for example.

For example, the growth unit 138 acquires a new node identifier. In addition, for example, the growth unit 138 acquires new node position information regarding a position that is in the direction indicated by the goal information that is paired with the one state determined by the state determination unit 137 and is a predetermined distance away from the position indicated by the node position information regarding the target node (firing node). In addition, for example, the growth unit 138 acquires information (for example, a firing condition or firing probability information) contained in the node information regarding the target node. Thereafter, for example, the growth unit 138 forms node information that contains one or more pieces of information of a new node identifier, new node position information, a firing condition, and firing probability information, and accumulates the node information in the NN storage unit 114. Note that the predetermined distance may be a distance determined in advance or may change dynamically.

It is preferable that the one or more node identifiers of the one or more node identifiers are, for example, one or more node identifiers contained in the node information that matches the node generation condition of the one or more node identifiers. However, the one or more node identifiers of the one or more node identifiers may be, for example, all of the one or more node identifiers.

The node generation condition is a condition for generating a node. The node generation condition is, for example, a condition based on difference information. For example, the node generation condition is “difference information>=threshold value” or “difference information>threshold value”. The node generation condition may be the same as or different from the edge generation condition. In addition, the node generation condition may be common to all nodes of interest, or may be different for each node. When the node generation condition is different for each node, the node information contains the node generation condition, for example.

### (4) Glial Cell Generation Processing

It is preferable that the growth unit 138 performs the glial cell generation processing described below. That is, for example, when the amount of energy retained in an element that is a node or edge becomes small enough to satisfy a predetermined condition with respect to the amount of required energy, the growth unit 138 generates glial cell information information regarding the glial cell connected to the element. Note that the element may be an axon or a dendrite. That is to say, when the amount of energy retained in an element that is an axon or a dendrite becomes small enough to satisfy a predetermined condition with respect to the amount of required energy, the growth unit 138 generates glial cell information regarding the glial cell connected to the element.

The predetermined condition is, for example, “retained energy amount <required energy amount”, or “retained energy amount<=required energy amount”, or “retained energy amount−required energy amount<=threshold value”, or “retained energy amount−required energy amount<threshold value”.

More specifically, for example, the growth unit 138 judges whether or not the amount of retained energy indicated by the retained energy amount information contained in the information of each element (node information, edge information, axon information, or dendrite information) is small enough to satisfy a predetermined condition than the amount of required energy indicated by the required energy amount information contained in the information of each element, and if it is judged that the amount is smaller, the growth unit 138 generates glial cell information that contains an identifier that identifies the element (a node identifier, an edge identifier, an axon identifier, or a dendrite identifier) and accumulates it in the storage unit 11.

The reference score change unit 139 changes the reference score in the reference score storage unit 113 based on the overall score acquired by the overall score acquisition unit 135. For example, the reference score change unit 139 changes the reference score to the overall score. For example, the reference score change unit 139 changes the reference score using an increasing function (e.g., average value or weighted average value) that takes the original reference score and the overall score as parameters.

It is preferable that the reference score change unit 139 changes the reference score in the reference score storage unit 113 only when the overall score matches the score change condition. It is preferable that the score change condition is a condition based on the difference information between the overall score and the reference score. For example, the score change condition is “difference information>=threshold value” or “difference information>threshold value”. Note that it is preferable for the degree of changing the reference score to be based on, for example, the difference information or the overall score. For example, the degree of changing the reference score is “the average value of the overall score and the reference score” or “the weighted average value of the overall score and the reference score”.

The output unit 14 outputs various kinds of information. Examples of the various kinds of information include the node identifier of a node that has fired, the NN information in the NN storage unit 114, and the state identifier acquired by the state determination unit 137.

Examples of the various kinds of information include a graphical representation of NN information. In such a case, the processing unit 13 forms a diagram of the nodes included in the NN (for example, spheres) from each piece of node information contained in the NN information, and forms a diagram of the edges included in the NN (for example, lines) from the edge information. In addition, the processing unit 13 places a diagram of the nodes (for example, spheres) at positions in virtual space indicated by the pieces of node position information contained in the pieces of node information, places a diagram of edges (for example, lines) whose end points are at positions in virtual space indicated by the pieces of edge position information of the pieces of edge information, and forms a diagram that explicitly shows that the nodes to which the edges are connected are connected to the diagram of the edges (e.g., lines).

Here, “output” is a concept that encompasses displaying on a display screen, projection using a projector, printing by a printer, the output of a sound, transmission to an external device, accumulation on a recording medium, delivery of a processing result to another processing device or another program, and the like.

It is preferable that the storage unit 11, the start point storage unit 111, the goal storage unit 112, the reference score storage unit 113, and the NN storage unit 114 are realized using a non-volatile recording medium, but they can be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12 and the information acceptance unit 121 can be realized using, for example, a wireless or wired communication means, a broadcast receiving means, a device driver for the input means such as a touch panel or a keyboard, or control software or the like for controlling the menu screen.

The processing unit 13, the image feature acquisition unit 131, the sound feature acquisition unit 132, the image score acquisition unit 133, the sound score acquisition unit 134, the overall score acquisition unit 135, the firing node determination unit 136, the growth unit 138, the state determination unit 137, and the reference score change unit 139 can typically be realized using a processor, a memory, or the like. The processing procedures performed by the processing unit 13 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The output unit 14 can be realized using, for example, the driver software of the output device, the driver software of the output device and the output device, a wireless or wired communication means, or broadcast means. Note that the output device is, for example, a display, a speaker, or the like.

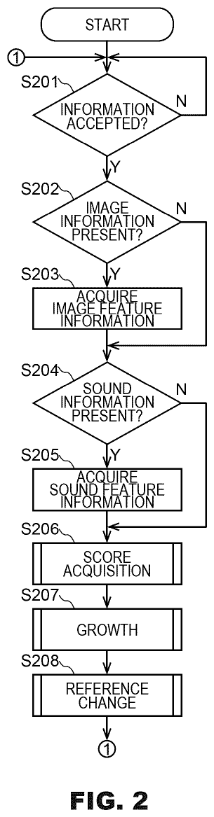

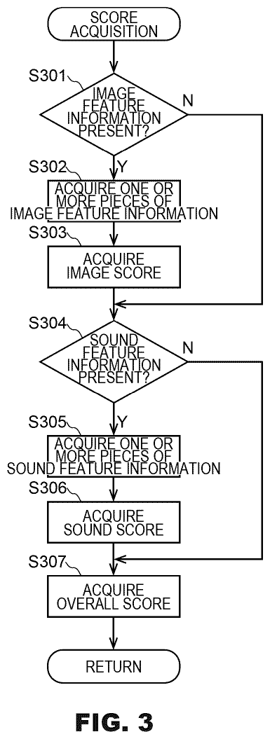

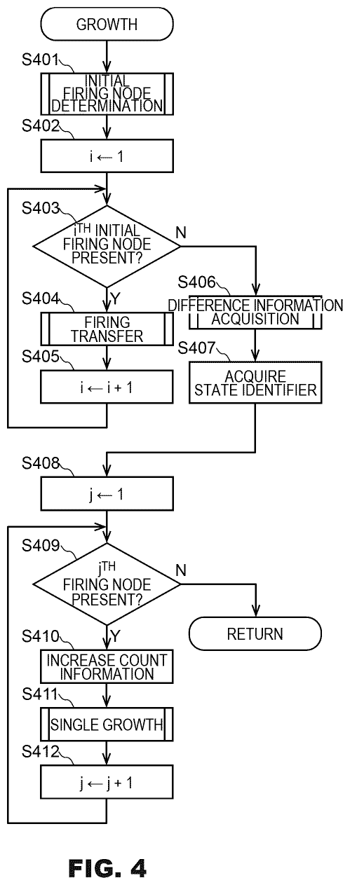

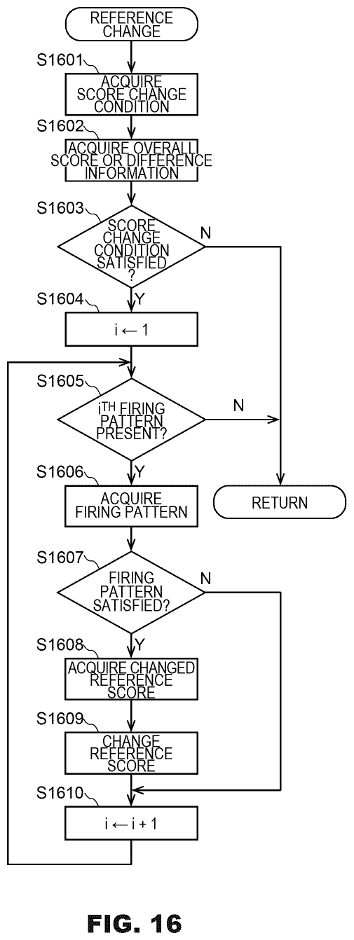

Next, examples of operations of the NN growth apparatus 1 will be described with reference to the flowchart in FIG. 2.
(Step S201) The information acceptance unit 121 judges whether or not information has been accepted. If information has been accepted, processing proceeds to step S202, and if information has not been accepted, processing returns to step S201.
(Step S202) The processing unit 13 judges whether or not image information is present in the information accepted in step S201. If image information is present, processing proceeds to step S203, and otherwise processing proceeds to step S204.
(Step S203) The image feature acquisition unit 131 acquires one or more pieces of image feature information from the image information accepted in step S201 and temporarily accumulates them in a buffer (not shown).
(Step S204) The processing unit 13 judges whether or not sound information is present in the information accepted in step S201. If sound information is present, processing proceeds to step S205, and otherwise processing proceeds to step S206.
(Step S205) The sound feature acquisition unit 132 acquires one or more pieces of sound feature information from the sound information accepted in step S201.
(Step S206) The overall score acquisition unit 135 and so on acquires the overall score. An example of such score acquisition processing will be described with reference to the flowchart in FIG. 3.
(Step S207) The growth unit 138 and so on perform growth processing. An example of growth processing will be described with reference to the flowchart in FIG. 4.
(Step S208) The reference score change unit 139 performs processing to change the reference score. Processing returns to step S201. An example of such reference change processing will be described with reference to the flowchart in FIG. 16.

Note that, in the flowchart shown in FIG. 2, processing is terminated when power is turned off or an interruption is made to terminate the processing.

Next, an example of the score acquisition processing in step S206 will be described with reference to the flowchart in FIG. 3.
(Step S301) The image score acquisition unit 133 judges whether or not image feature information is present in the acquired feature information. If image feature information is present, processing proceeds to step S302, and otherwise processing proceeds to step S304.
(Step S302) The image score acquisition unit 133 acquires one or more pieces of image feature information in the acquired feature information from a buffer (not shown).
(Step S303) The image score acquisition unit 133 acquires the image score using the one or more pieces of image feature information acquired in step S302.
(Step S304) The sound score acquisition unit 134 judges whether or not sound feature information is present in the acquired feature information. If sound feature information is present, processing proceeds to step S305, and otherwise processing proceeds to step S307.
(Step S305) The sound score acquisition unit 134 acquires one or more pieces of sound feature information in the acquired feature information from a buffer (not shown).
(Step S306) The sound score acquisition unit 134 acquires the sound score using the one or more pieces of sound feature information acquired in step S302.
(Step S307) The overall score acquisition unit 135 acquires the overall score using one or more scores among the acquired image score or sound score. Processing returns to the higher-level processing.

Note that the one or more pieces of acquired feature information are one or more kinds of information of the one or more pieces of image feature information acquired in step S302 and the one or more pieces of sound feature information acquired in step S305.

Note that, in the flowchart shown in FIG. 3, the overall score acquisition unit 135 may acquire the overall score using the one or more pieces of acquired feature information without using the image score or the sound score.

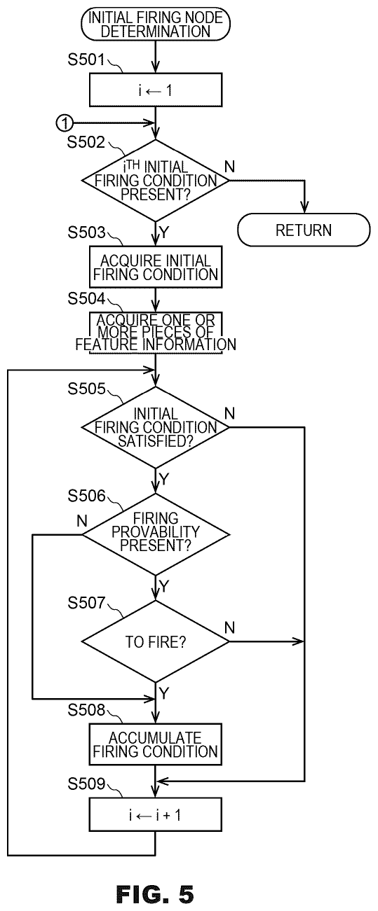

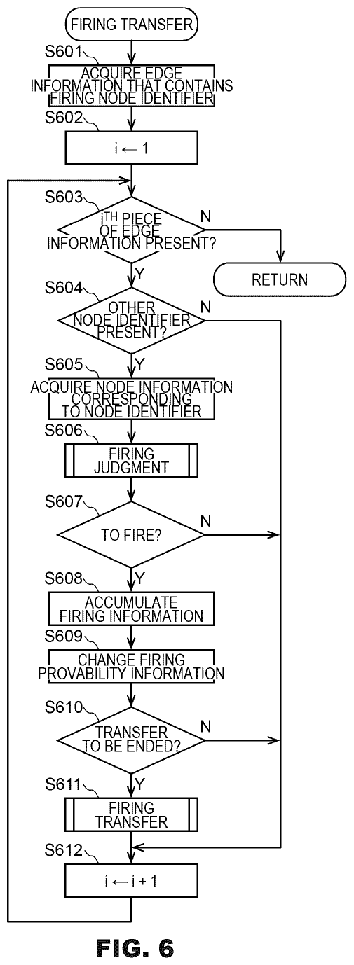

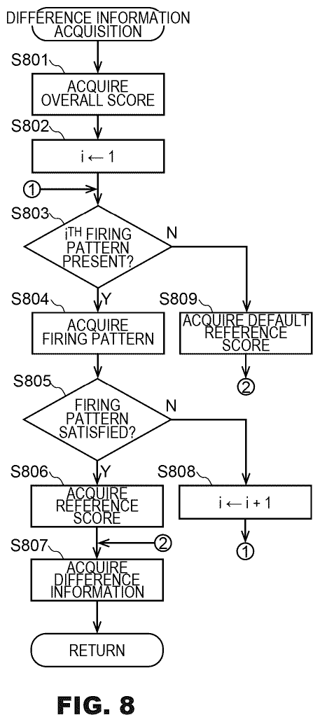

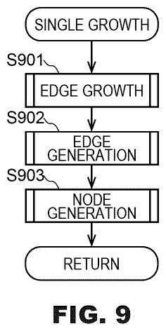

Next, an example of the growth processing in step S207 will be described with reference to the flowchart in FIG. 4.
(Step S401) The firing node determination unit 136 performs processing to determine the node that initially fires. An example of such initial firing node determination processing will be described with reference to the flowchart in FIG. 5.
(Step S402) The firing node determination unit 136 substitutes 1 for a counter i.
(Step S403) The firing node determination unit 136 judges whether or not an i^{th} initial firing node is present in the initial firing nodes determined in step S401. If the i^{th} initial firing node is present, processing proceeds to step S404, and otherwise processing proceeds to step S406.
(Step S404) The firing node determination unit 136 performs firing transfer processing. An example of firing transfer processing will be described with reference to the flowchart in FIG. 6.
(Step S405) The firing node determination unit 136 increments the counter i by 1. Processing returns to step S403.
(Step S406) The state determination unit 137 acquires difference information. An example of difference information acquisition processing will be described with reference to the flowchart in FIG. 8.
(Step S407) The state determination unit 137 acquires the state identifier corresponding to the difference information acquired in step S406. Note that, for example, the state determination unit 137 references a correspondence table containing two or more pieces of correspondence information indicating the correspondence between conditions of difference information and state identifiers, and acquires the state identifier paired with the condition that matches the acquired difference information. The correspondence table is stored in the storage unit 11.
(Step S408) The growth unit 138 substitutes 1 for a counter j.
(Step S409) The growth unit 138 judges whether or not a j^{th} firing node is present in the nodes that fired from step S401 to step S405. If the j^{th} firing node is present, processing proceeds to step S408, and otherwise processing returns to the higher-level processing.
(Step S410) The growth unit 138 increases the count information paired with the node identifier of the j^{th} firing node by 1.
(Step S411) The growth unit 138 performs single growth processing on the j^{th} firing node. An example of single growth processing will be described with reference to the flowchart in FIG. 9.

Note that single growth processing refers to the growth processing performed to grow one firing node and the edges connected to the node.
(Step S412) The growth unit 138 increments the counter j by 1. Processing returns to step S407.

Next, an example of the initial firing node determination processing in step S401 will be described with reference to the flowchart in FIG. 5.
(Step S501) The firing node determination unit 136 substitutes 1 for the counter i.
(Step S502) The firing node determination unit 136 judges whether or not the i^{th} initial firing condition is present in the start point storage unit 111. If the i^{th} initial firing condition is present, processing proceeds to step S503, and otherwise processing returns to the higher-level processing.
(Step S503) The firing node determination unit 136 acquires the i^{th} initial firing condition from the start point storage unit 111.
(Step S504) The firing node determination unit 136 acquires one or more pieces of feature information used to judge the i^{th} initial firing condition from a buffer (not shown). Note that, for example, each of the one or more pieces of feature information is image feature information or sound feature information.
(Step S505) The firing node determination unit 136 judges whether or not the one or more pieces of feature information acquired in step S504 satisfy the i^{th} initial firing condition acquired in step S503. If the i^{th} initial firing condition is satisfied, processing proceeds to step S506, and otherwise processing proceeds to step S509.
(Step S506) The firing node determination unit 136 references the NN storage unit 114 and judges whether or not a firing probability is present in pair with the firing node identifier paired with the i^{th} initial firing condition. If the firing probability is present, processing proceeds to step S507, and otherwise processing proceeds to step S508.
(Step S507) The firing node determination unit 136 judges whether or not to fire this time using the firing probability paired with the firing node identifier paired with the i^{th} initial firing condition. If firing occurs, processing proceeds to step S508, and otherwise processing proceeds to step S509.
(Step S508) The firing node determination unit 136 acquires firing information containing the firing node identifier paired with the i^{th} initial firing condition and accumulates the firing information in the storage unit 11.
(Step S509) The firing node determination unit 136 increments the counter i by 1. Processing returns to step S502.

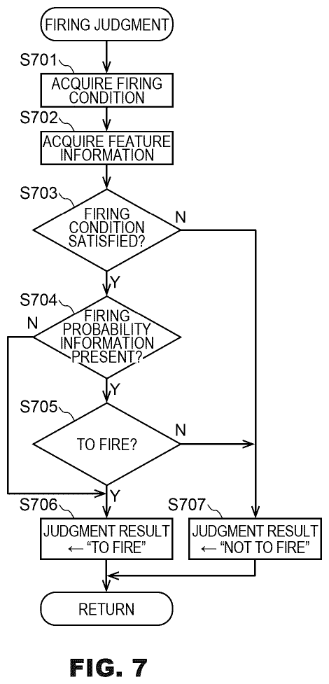

Next, an example of the firing transfer processing in step S404 will be described with reference to the flowchart in FIG. 6.
(Step S601) The firing node determination unit 136 acquires all pieces of edge information that contain the firing node identifier as the identifier of the connection origin node from the NN storage unit 114. Note that the firing node identifier here is, for example, the node identifier of the i^{th} initial firing node in step S403.
(Step S602) The firing node determination unit 136 substitutes 1 for a counter i.
(Step S603) The firing node determination unit 136 judges whether or not an i^{th} piece of edge information is present in the edge information acquired in step S601. If the i^{th} piece of edge information is present, processing proceeds to step S604, and otherwise processing returns to the higher level processing.
(Step S604) The firing node determination unit 136 judges whether or not the node identifier of another node is present in the i^{th} piece of edge information. If the node identifier of another node is present, processing proceeds to step S605, and otherwise processing proceeds to step S612. Note that the node identifier of another node in the edge information is the node identifier of the connection destination node of the edge.
(Step S605) The firing node determination unit 136 acquires the node identifier of another node in the i^{th} piece of edge information. Next, the firing node determination unit 136 acquires, from the NN storage unit 114, the node information regarding the node identified by the node identifier.
(Step S606) Using the node information acquired in step S605, the firing node determination unit 136 judges whether or not the node corresponding to the node information fires. An example of such firing judgment processing will be described with reference to the flowchart in FIG. 7.
(Step S607) If the judgment result in step S606 is “to fire”, the firing node determination unit 136 proceeds to step S608, and if the judgment result is “not to fire”, the firing node determination unit 136 proceeds to step S612.
(Step S608) The firing node determination unit 136 acquires firing information containing the node identifier contained in the node information acquired in step S605 and accumulates the firing information in the storage unit 11.
(Step S609) The firing node determination unit 136 changes the firing probability information contained in the node information acquired in step S605. Here, the firing node determination unit 136 changes the firing probability information so that the firing probability specified by the firing probability information increases. Note that there is no limitation on the amount of increase.
(Step S610) The firing node determination unit 136 judges whether or not to end the transfer of firing between nodes (which may also be referred to as the transfer of information). If the transfer is to be ended, processing proceeds to step S612, and otherwise processing proceeds to step S611. Note that the case where the transfer is to be ended is, for example, the case where the node is a terminal node in the NN.
(Step S611) The firing node determination unit 136 performs firing transfer processing where the node is the node of interest. An example of firing transfer processing is shown in FIG. 6.
(Step S612) The firing node determination unit 136 increments the counter i by 1. Processing returns to step S603.

Note that, in the flowchart shown in FIG. 6, it is preferable for the firing node determination unit 136 to update retained energy amount information by subtracting the energy amount indicated by the retained energy amount information contained in the node information of the node that triggered the firing when the transfer of firing between nodes (transfer of information) has been performed. The same may also be applied to the retained energy amount information that is paired with the axon identifier of the axon used for the transfer, and the retained energy amount information that is paired with the dendrite identifier of the dendrite used for the transfer. In addition, it is assumed that the function for reducing the amount of energy is stored in the storage unit 11, for example. There is no limitation on the function. The function is a well-known technique, and therefore a detailed description will be omitted.

In the flowchart shown in FIG. 6, the firing node determination unit 136 typically performs processing to pass one or more pieces of feature information accepted by the firing origin node to the destination node that will fire.

Next, an example of the firing judgment processing in step S606 will be described with reference to the flowchart in FIG. 7.
(Step S701) The firing node determination unit 136 acquires the firing condition corresponding to the node information acquired in step S605.
(Step S702) The firing node determination unit 136 acquires one or more pieces of feature information. Note that the one or more pieces of feature information are pieces of feature information transferred from the firing origin node.
(Step S703) The firing node determination unit 136 judges whether or not the one or more pieces of feature information acquired in step S702 satisfy the firing condition acquired in step S701. If the firing condition is satisfied, processing proceeds to step S704, and if the firing condition is not satisfied, processing proceeds to step S707.
(Step S704) The firing node determination unit 136 judges whether or not the node information of the node of interest contains firing probability information. If the firing probability information is contained, processing proceeds to step S705, and if the firing condition is not contained, processing proceeds to step S706.
(Step S705) The firing node determination unit 136 acquires the firing probability information contained in the node information of the node of interest. Next, using the firing probability information, the firing node determination unit 136 judges whether or not the node is to fire. If the node is to fire, processing proceeds to step S706, and otherwise processing proceeds to step S707.
(Step S706) The firing node determination unit 136 substitutes “to fire” for the judgment result. Processing returns to higher level processing.
(Step S707) The firing node determination unit 136 substitutes “to fire” for the judgment result. Processing returns to higher level processing.

Next, an example of the difference information acquisition processing in step S406 will be described with reference to the flowchart in FIG. 8.
(Step S801) The state determination unit 137 acquires the overall score acquired in step S206.
(Step S802) The state determination unit 137 substitutes 1 for a counter i.
(Step S803) The state determination unit 137 judges whether or not an i^{th} firing pattern is present in the reference score storage unit 113. If the i^{th} firing pattern is present, processing proceeds to step S804, and otherwise processing proceeds to step S809.
(Step S804) The state determination unit 137 acquires the i^{th} firing pattern.
(Step S805) The state determination unit 137 references one or two or more pieces of firing information in the storage unit 11 and judges whether or not the firing pattern acquired in step S804 is satisfied. If the firing pattern is satisfied, processing proceeds to step S806, and otherwise processing proceeds to step S808.
(Step S806) The state determination unit 137 acquires the reference score paired with the i^{th} firing pattern from the reference score storage unit 113.
(Step S807) The state determination unit 137 acquires difference information using the acquired overall score and the acquired reference score. Processing returns to higher level processing.
(Step S808) The state determination unit 137 increments the counter i by 1. Processing returns to step S803.
(Step S809) The state determination unit 137 acquires the default reference score from the reference score storage unit 113. Processing proceeds to step S807.

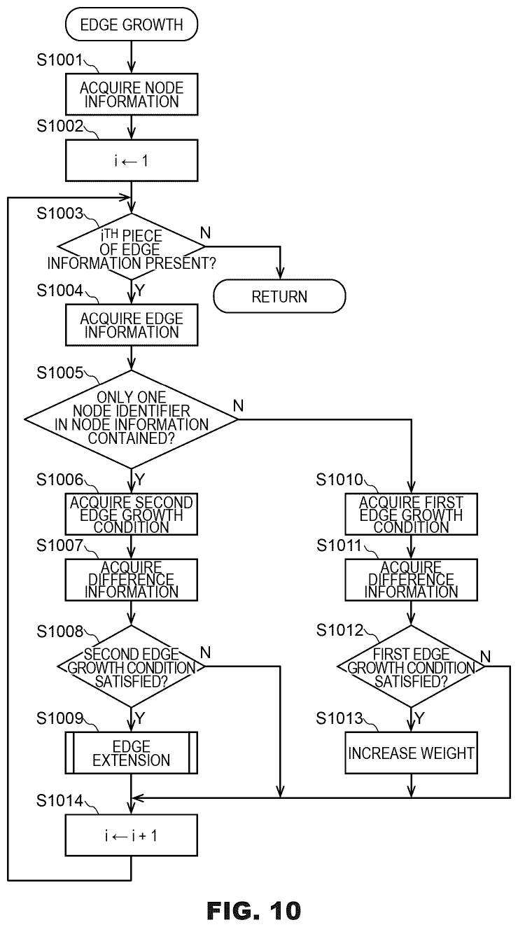

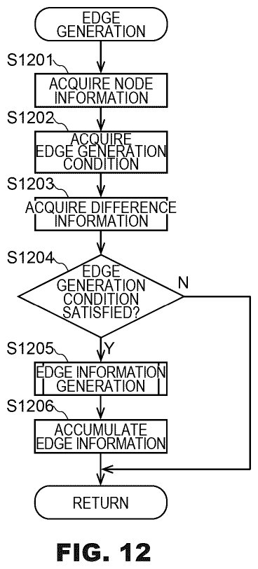

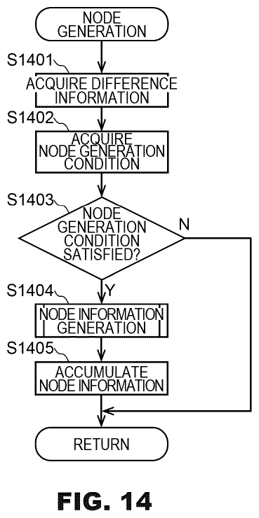

Next, the single growth processing in step S509 is performed. An example of single growth processing will be described with reference to the flowchart in FIG. 9.
(Step S901) The growth unit 138 performs edge growth processing. An example of edge growth processing will be described with reference to the flowchart in FIG. 10.
(Step S902) The growth unit 138 performs edge generation processing. An example of edge generation processing will be described with reference to the flowchart in FIG. 12.
(Step S903) The growth unit 138 performs node generation processing. Processing returns to higher level processing. An example of node generation processing will be described with reference to the flowchart in FIG. 14.

Note that the flowchart in FIG., may be performed.

Next, an example of the edge growth processing in step S901 will be described with reference to the flowchart in FIG. 10.
(Step S1001) The growth unit 138 acquires node information identified by the node-of-interest identifier from the NN storage unit 114.
(Step S1002) The growth unit 138 substitutes 1 for the counter i.
(Step S1003) The growth unit 138 judges whether or not the i^{th} piece of edge information in the pieces of edge information of the edges whose connection origin node is the node identified by the node-of-interest identifier is present in the NN storage unit 114. If the i^{th} piece of edge information is present, processing proceeds to step S1004, and otherwise processing returns to higher level processing.
(Step S1004) The growth unit 138 acquires the i^{th} piece of edge information from the NN storage unit 114.
(Step S1005) The growth unit 138 judges whether or not a node is connected to the end of the edge corresponding to the i^{th} piece of edge information. More specifically, the growth unit 138 judges whether or not the node identifier contained in the i^{th} piece of edge information is only the node-of-interest identifier. If the node identifier is only the node of interest identifier, processing proceeds to step S1006, and if the node identifier is not only the node of interest identifier (when two node identifiers are present), processing proceeds to step S1010. Note that edge information containing only the node of interest identifier is information of an edge connected to the node of interest and capable of growth. On the other hand, edge information containing two node identifiers is information of an edge that does not grow.
(Step S1006) The growth unit 138 acquires the second edge growth condition.
(Step S1007) The growth unit 138 acquires the difference information acquired in step S207.
(Step S1008) The growth unit 138 judges whether or not the difference information acquired in step S1007 satisfies the second edge growth condition. If the second edge growth condition is satisfied, processing proceeds to step S1009, and otherwise processing proceeds to step S1014.
(Step S1009) The growth unit 138 performs edge extension processing. Processing proceeds to step S1014. An example of edge extension processing will be described with reference to the flowchart in FIG. 10.

Note that edge extension processing is processing performed to extend the length of an edge, and is typically processing performed to change edge position information or processing performed to add the node identifier of the connection destination node to edge information.
(Step S1010) The growth unit 138 acquires the first edge growth condition.
(Step S1011) The growth unit 138 acquires the difference information acquired in step S207.
(Step S1012) The growth unit 138 judges whether or not the difference information acquired in step S1011 satisfies the first edge growth condition. If the first edge growth condition is satisfied, processing proceeds to step S1013, and otherwise processing proceeds to step S1014.
(Step S1013) The growth unit 138 changes the weight contained in the i^{th} piece of edge information to an increased weight.
(Step S1014) The growth unit 138 increments the counter i by 1. Processing returns to step S1003.

Note that, in the flowchart in FIG. 10, edge growth processing may be replaced with dendrite growth processing for the dendrites included in edges, or axon growth processing for axons.

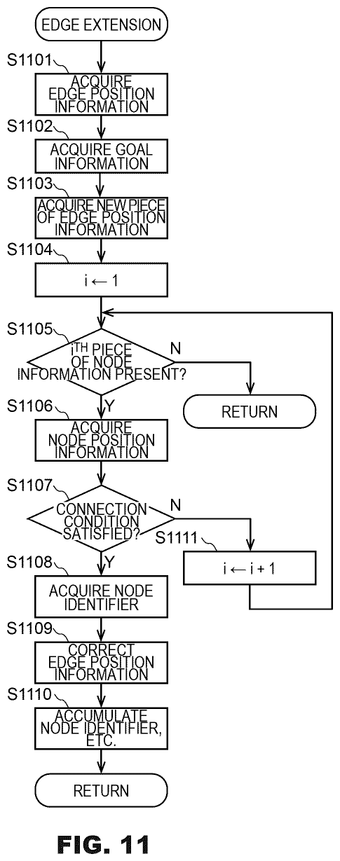

Next, an example of edge extension processing in step S1009 will be described with reference to the flowchart in FIG. 11.
(Step S1101) The growth unit 138 acquires edge position information contained in the acquired edge information.
(Step S1102) The growth unit 138 acquires goal information.
(Step S1103) Using the edge position information acquired in step S1101 and the goal information acquired in step S1102, the growth unit 138 acquires new edge position information and updates the edge position information. Note that the growth unit 138 acquires, from the edge position information, position information that specifies a position in the direction indicated by the goal information.

The growth unit 138 acquires, for example, edge position information indicating a position that is a predetermined distance away from the position indicated by the edge position information acquired in step S1101 in the direction specified by the goal information. For example, if there is another node in the direction specified by the goal information with respect to the position indicated by the edge position information acquired in step S1101, the growth unit 138 acquires edge position information indicating a position that is between the position indicated by the edge position information and the position indicated by the node position information of the other node in the direction specified by the goal information, and that is away therefrom by a distance within a predetermined distance range. For example, when another node is present in the direction specified by the goal information from the position indicated by the edge position information acquired in step S1101, the growth unit 138 acquires the node position information of the other node as edge position information. That is to say, when the growth unit 138 acquires new edge position information, the growth unit 138 need only acquire edge position information in the direction specified by the goal information from the current edge position information, and there is no limitation on the edge position information. Note that when node position information of another node is acquired as edge position information, the edge is connected to the other node by edge extension processing, as described later. In such a case, the growth unit 138 may acquire the node identifier of the other node.
(Step S1104) The growth unit 138 substitutes 1 for the counter i.
(Step S1105) The growth unit 138 judges whether or not the i^{th} piece of node information is present in the NN storage unit 114. If the i^{th} piece of node information is present, processing proceeds to step S1106, and otherwise processing returns to higher level processing.
(Step S1106) The growth unit 138 acquires the node position information contained in the i^{th} piece of node information.
(Step S1107) The growth unit 138 judges whether or not the node position information acquired in step S1106 satisfies a connection condition. If the connection condition is satisfied, processing proceeds to step S1108, and otherwise processing proceeds to step S1111. Note that the connection condition is a condition for an edge to be connected to a node. The connection condition is, for example, that the distance between the position indicated by the node position information acquired in step S1106 and the position indicated by the new piece of edge position information acquired in step S1103 is not greater than a threshold value or less than a threshold value.
(Step S1108) The growth unit 138 acquires the node identifier contained in the i^{th} piece of node information.
(Step S1109) The growth unit 138 changes the edge position information updated in step S1103 to the node position information contained in the i^{th} piece of node information.
(Step S1110) The growth unit 138 adds the node identifier acquired in step S1108 to the acquired edge information. Processing returns to higher level processing.
(Step S1111) The growth unit 138 increments the counter i by 1. Processing returns to step S1105.

Note that, in the flowchart in FIG. 11, edge extension processing may be replaced with dendrite growth processing for the dendrites included in edges, or axon growth processing for axons.

Dendrite extension processing is processing performed to extend a dendrite, and is processing in which edge information is replaced with dendrite information in the processing described with reference to FIG. 11. Axon extension processing is processing performed to extend an axon, and is processing in which edge information is replaced with axon information in the processing described with reference to FIG. 11.

In the flowchart in FIG. 11, processing may proceed to step S1111 after the processing in step S1110. In such a case, an edge may branch and connect to two or more nodes.

In addition, in step S1107 in the flowchart in FIG. 11, the distance between the new piece of edge position information acquired in step S1103 and the node position information of each node may be calculated, and it may be judged whether or not the node position information of the node with the smallest distance satisfies the connection condition.

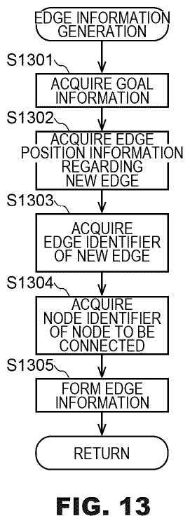

Next, an example of the edge generation processing in step S902 will be described with reference to the flowchart in FIG. 12.
(Step S1201) The growth unit 138 acquires node information identified by the node-of-interest identifier from the NN storage unit 114.
(Step S1202) The growth unit 138 acquires edge generation condition.
(Step S1203) The growth unit 138 reads out the difference information already acquired.
(Step S1204) The growth unit 138 judges whether or not the difference information acquired in step S1203 satisfies the edge generation condition. If the edge generation condition is satisfied, processing proceeds to step S1204, and otherwise processing returns to higher level processing.
(Step S1205) The growth unit 138 performs edge information generation processing. An example of edge information generation processing will be described with reference to the flowchart in FIG. 13.
(Step S1206) The growth unit 138 accumulates the edge information formed in step S1205 in the NN storage unit 114. Processing returns to higher level processing.

Next, an example of the edge information generation processing in step S1205 will be described with reference to the flowchart in FIG. 13.
(Step S1301) The growth unit 138 acquires the goal information corresponding to the state identifier acquired in step S208 from the goal storage unit 112.
(Step S1302) The growth unit 138 acquires edge position information for a new edge using the node position information of the node of interest (the node for which an edge is generated) and the goal information acquired in step S1301. The growth unit 138 acquires edge position information regarding an edge extending from the position indicated by the node position information in the direction indicated by the goal information. Note that, for example, the distance between the position indicated by the edge position information and the position indicated by the node position information may or may not be determined in advance.

The growth unit 138 acquires, for example, edge position information indicating a position that is away from the position indicated by the node position information of the node of interest by a predetermined distance in the direction specified by the goal information. For example, when another node is present in the direction specified by the goal information from the position indicated by the node position information of the node of interest, the growth unit 138 acquires the node position information of the other node as edge position information. That is to say, here, the generated edge is an edge that connects the node corresponding to the node position information of the node of interest with the other node. The growth unit 138 acquires, for example, node position information indicating a position that is away from the position indicated by the node position information of the node of interest by a predetermined distance in the direction specified by the goal information when another node is present in that direction and the distance between the position indicated by the node position information of the node of interest and the position indicated by the node position information of the other node is no less than a threshold value or greater than a threshold value, and acquires the node position information of the other node as edge position information when the distance between the position indicated by the node position information of the node of interest and the position indicated by the node position information of the other node is less than a threshold value or no greater than a threshold value. That is to say, the growth unit 138 need only acquire edge position information of an edge extending from the position indicated by the node position information in the direction indicated by the goal information, and there is no limitation on the edge position information.
(Step S1303) The growth unit 138 acquires the edge identifier of a new edge. For example, the growth unit 138 generates a new node identifier. For example, the growth unit 138 acquires an unused edge identifier from a raw set of edge identifiers.
(Step S1304) The growth unit 138 acquires the node identifier (node-of-interest identifier) of the node to which the edge is connected. Here, the growth unit 138 acquires the node identifier paired with the node position information of the node of interest. The growth unit 138 may acquire the node identifier of the newly connected node.
(Step S1305) The growth unit 138 forms edge information containing the edge identifier acquired in step S1303, the edge position information acquired in step S1302, and one or two node identifiers acquired in step S1304. Processing returns to higher level processing.

Note that, in the flowchart shown in FIG. 13, the edge corresponding to the generated edge information may be in a state where there is no node connected ahead, or may be in a state where there is a node connected ahead.

If there is a node connected ahead to the edge corresponding to the generated edge information, the growth unit 138 acquires the node identifier that is paired with the node position information regarding the position in the direction indicated by the goal information as the node identifier of the connected node. Note that when the growth unit 138 always forms and accumulates edge information such that a generated edge connects two nodes, edge growth processing is not performed normally.

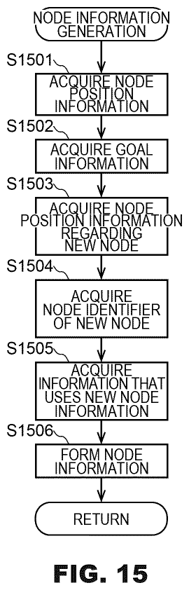

Next, an example of the node generation processing in step S903 will be described with reference to the flowchart in FIG. 14.
(Step S1401) The growth unit 138 acquires difference information.
(Step S1402) The growth unit 138 acquires a node generation condition.
(Step S1403) The growth unit 138 judges whether or not the difference information acquired in step S1401 satisfies the node generation condition acquired in step S1402. If the node generation condition is satisfied, processing proceeds to step S1404, and if the node generation condition is not satisfied, processing returns to higher level processing.
(Step S1404) The growth unit 138 performs node information generation processing. An example of node information generation processing will be described with reference to the flowchart in FIG. 15.
(Step S1405) The growth unit 138 accumulates the node information formed in step S1404 in the NN storage unit 114. Processing returns to higher level processing.

Next, an example of the node information generation processing in step S1404 will be described with reference to the flowchart in FIG. 15.
(Step S1501) The growth unit 138 acquires the node position information contained in the node-of-interest information identified by the node-of-interest identifier.
(Step S1502) The growth unit 138 acquires the goal information corresponding to the state identifier acquired in step S407 from the goal storage unit 112.
(Step S1503) The growth unit 138 acquires node position information indicating a position in the direction specified by the goal information relative to the position indicated by the node position information acquired in step S1501, using the node position information acquired in step S1501 and the goal information acquired in step S1502. Such node position information is position information regarding a new node.

The growth unit 138 acquires, for example, node position information indicating a position that is a predetermined distance away from the position indicated by the node position information acquired in step S1501 in the direction specified by the goal information. For example, when another node exists in the direction specified by the goal information from the position indicated by the node position information acquired in step S1501, the growth unit 138 acquires node position information indicating a position away from the position indicated by the node position information acquired in step S1501 by a distance within a predetermined distance and between the position indicated by the node position information acquired in step S1501 and the node position information of another node in the direction specified by the goal information. That is to say, when the growth unit 138 acquires node position information of a new node, the growth unit 138 need only acquire node position information in the direction specified by the goal information, and there is no limitation on the node position information.
(Step S1504) The growth unit 138 acquires the node identifier of the new node. The growth unit 138 generates a new node identifier. However, the growth unit 138 may acquire an unused node identifier from the set of node identifiers.
(Step S1505) The growth unit 138 acquires information contained in the node information of the node of interest, which is information to be used in the node information of a new node. Examples of such information include a firing condition, firing probability information, and retained energy amount information.
(Step S1506) The growth unit 138 forms node information containing the node identifier acquired in step S1504, the node position information acquired in step S1503, and the information acquired in step S1505. Processing returns to higher level processing.

Next, an example of the reference change processing in step S208 will be described with reference to the flowchart in FIG. 16.
(Step S1601) The reference score change unit 139 acquires the score change condition from the storage unit 11.
(Step S1602) The reference score change unit 139 acquires the overall score or difference information from a buffer (not shown).
(Step S1603) The reference score change unit 139 judges whether or not the overall score or difference information satisfies the score change condition. If the score change condition is satisfied, processing proceeds to step S1604, and if the score change condition is not satisfied, processing returns to higher level processing.
(Step S1604) The reference score change unit 139 judges whether or not the i^{th} firing pattern is present in the reference score storage unit 113. If the i^{th} firing pattern is present, processing proceeds to step S1605, and otherwise processing returns to higher level processing.
(Step S1605) The reference score change unit 139 substitutes 1 for the counter i.
(Step S1606) The reference score change unit 139 acquires the i^{th} firing pattern from the reference score storage unit 113.
(Step S1607) The reference score change unit 139 references the firing information (information of the nodes that fired) in the storage unit 11 and judges whether or not the i^{th} firing pattern is satisfied. If the i^{th} firing pattern is satisfied, processing proceeds to step S1608, and otherwise processing proceeds to step S1610. Note that when the i^{th} firing pattern is satisfied, it is typically the case where all node identifiers contained in the firing pattern are included in the set of node identifiers of the nodes that fired. However, when the i^{th} firing pattern is satisfied, it may also be the case, for example, where a proportion equal to or greater than a threshold value of the node identifiers contained in the firing pattern is included in the set of node identifiers of the nodes that fired.
(Step S1608) The reference score change unit 139 acquires the reference score paired with the i^{th} firing pattern from the reference score storage unit 113. The reference score change unit 139 acquires the changed reference score using the acquired reference score.

When the state identifier is “positive”, the changed reference score is typically a value greater than the original reference score. When the state identifier is “negative”, the changed reference score is typically a value smaller than the original reference score.
(Step S1609) The reference score change unit 139 changes the reference score paired with the i^{th} firing pattern to the reference score acquired in step S1608.
(Step S1610) The reference score change unit 139 increments the counter i by 1. Processing returns to step S1606.

Note that, in the flowchart shown in FIG. 16, the score change condition may differ for each firing pattern. In such a case, when the score change condition paired with the firing pattern judged to be satisfied in step S1607 is satisfied, the score change condition paired with the firing pattern is changed.

In addition, in the flowchart shown in FIG. 16, the reference score change unit 139 may change one default reference score.

As described above, with the present embodiment, it is possible to simulate brain growth. In particular, with the NN growth apparatus 1, it is possible to simulate, for example, the brain growth of a person after infancy.

Note that the processing in the present embodiment may be realized using software. This software may be distributed through software downloading or the like. Also, this software may be recorded on a recording medium such as a CD-ROM and distributed. Note that the same applies to the other embodiments in the present description. Note that the software that realizes the NN growth apparatus 1 according to the present embodiment is the program described below. That is to say, this program is a program that enables a computer that can access: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information each containing one or more node identifiers identifying nodes that fire without going through other nodes are stored, in association with an initial firing condition that is a condition related to one or more kinds of feature information of one or more pieces of image feature information for image information and one or more pieces of sound feature information for sound information, and that is a condition for determining nodes that fire without going through other nodes; and a reference score storage unit in which a reference score related to a positive state or a negative state is stored, to function as: an information acceptance unit that accepts image information and sound information; an image feature acquisition unit that acquires, using the image information accepted by the information acceptance unit, one or more pieces of image feature information corresponding to the image information; a sound feature acquisition unit that acquires, using the sound information accepted by the information acceptance unit, one or more pieces of sound feature information corresponding to the sound information; an overall score acquisition unit that acquires an overall score based on the one or more pieces of image feature information and the one or more pieces of sound feature information; a firing node determination unit that determines, from the start point storage unit, one or more node identifiers paired with the initial firing condition that matches one or more kinds of information of the one or more pieces of image feature information and the one or more pieces of sound feature information, and determines, for each of the nodes identified by the one or more node identifiers, a node identifier of a firing node that is connected by an edge, receives one or more kinds of information of the one or more pieces of image feature information and the one or more pieces of sound feature information; and a growth unit that performs growth processing, which is processing to grow edge information of one or more edges connected to each of one or more nodes identified by one or more node identifiers of the one or more node identifiers determined by the firing node determination unit, based on difference information regarding a difference between the overall score and the reference score.

### Second Embodiment

The present embodiment describes an information processing apparatus that uses neural network information generated by the NN generation apparatus 1 to acquire a firing pattern corresponding to the accepted image information and/or sound information and output information corresponding to the firing pattern.

The present embodiment also describes an information processing apparatus in which the speed of information transfer between nodes changes depending on temperature information.

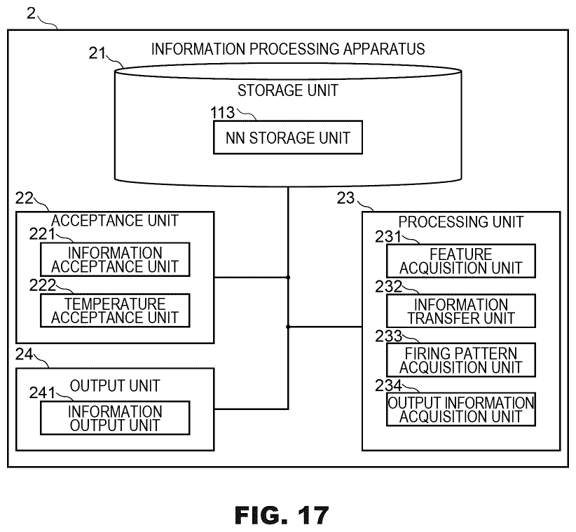

FIG. 17 is a block diagram of an information processing apparatus 2 according to the present embodiment. The information processing apparatus 2 includes a storage unit 21, an acceptance unit 22, a processing unit 23, and an output unit 24. The storage unit 21 includes a start point storage unit 111 and an NN storage unit 114. The acceptance unit 22 includes an information acceptance unit 221 and a temperature acceptance unit 222. The processing unit 23 includes a feature acquisition unit 231, an information transfer unit 232, a firing pattern acquisition unit 233, and an output information acquisition unit 234. The output unit 24 includes an information output unit 241.

The storage unit 21 included in the information processing apparatus 2 stores various kinds of information. Examples of the various kinds of information include neural network information, one or more pieces of firing start point information, and one or more pieces of output management information.

The firing start point information is information containing an information identifier that identifies feature information of acceptance information, and one or more node identifiers that identify nodes that fire first when the feature information is accepted.

The acceptance information is information accepted by the information acceptance unit 221. The acceptance information contains one or two kinds of. information of image information; and sound information. The acceptance information may be two or more kinds of information. The acceptance information may contain, for example, tactile information and smell information. The tactile information is information related to the sense of touch. The tactile information is information related to the sense of touch.

The output management information is information that contains an output condition and output information. The output management information may be information consisting of a pair of an output condition and output information.

The output condition is a condition used to determine output information. The output condition is a condition for outputting using the firing pattern. The output condition may be the firing pattern itself, or information that contains the firing pattern and output probability information. The output probability information is information regarding the probability for acquiring the output information. The output condition may be a firing pattern and information regarding a lower limit of the number of node identifiers that the applied firing pattern has, a firing pattern and information regarding a lower limit of the ratio of node identifiers that the applied firing pattern has, or the like. The firing pattern contains one or more node identifiers. The firing pattern is a pattern of firing of one or more nodes. The output information is information corresponding to the firing pattern.

The output information is, for example, emotion information regarding the emotion of a person, behavior information regarding the body movement of a person, and the like. The emotion information indicates, for example, happiness, sadness, fear, surprise, or the like. The emotion information is, for example, an ID that identifies an emotion. The emotion information may be the state identifier described above. The behavior information is, for example, information reflected in the movement of an avatar (character). The behavior information is, for example, information reflected in the movements of an infant avatar. The technology for moving an avatar is a well-known technology, and therefore a detailed description thereof will be omitted.

The output condition may be a condition using the firing pattern and one or more pieces of information related to external information. External information is information that is external. The external information may be referred to as user context. The external information is, for example, temperature, weather, smell, sound, light, or the like.

The NN storage unit 114 stores the neural network information accumulated by the NN growth apparatus 1.

The acceptance unit 22 accepts various kinds of information. Example of the various kinds of information include acceptance information and temperature information.

The information acceptance unit 221 accepts acceptance information. The information acceptance unit 221 acquires, for example, image information acquired by a camera. The information acceptance unit 221 may accept sound information acquired by a microphone. The acceptance information may contain both image information and sound information.

The “acceptance” here is a concept that includes, for example, acceptance of information acquired by a device such as a camera or a microphone, reception of information transmitted via a wired or wireless communication network, or acceptance of information read out from a recording medium such as an optical disk, a magnetic disk, or a semiconductor memory.

The temperature acceptance unit 222 accepts temperature information. Temperature information is information that specifies a temperature. The temperature is, for example, the temperature of the external environment.

The “acceptance” here is a concept that includes, for example, acceptance of information input from an input device such as a microphone, a keyboard, a mouse, or a touch panel, reception of information transmitted via a wired or wireless communication network, or acceptance of information read out from a recording medium such as an optical disk, a magnetic disk, or a semiconductor memory.

The processing unit 23 performs various kinds of processing. The various kinds of processing are, for example, the processing performed by the feature acquisition unit 231, the information transfer unit 232, the firing pattern acquisition unit 233, and the output information acquisition unit 234.

The feature acquisition unit 231 uses the image information accepted by the information acceptance unit 221 to acquire one or more pieces of image feature information corresponding to the image information. The feature acquisition unit 231 uses the sound information accepted by the information acceptance unit 221 to acquire one or more pieces of sound feature information corresponding to the sound information.

The processing performed by the feature acquisition unit 231 may be the same as the processing performed by one or two constituent elements of: the image feature acquisition unit 131; and the sound feature acquisition unit 132.

The information transfer unit 232 determines node identifiers corresponding to the one or more pieces of feature information acquired by the feature acquisition unit 231 from one or more pieces of firing start point information. Such node identifiers are firing node identifiers. Such node identifiers are the identifiers of the nodes that fire in the first stage.

Next, the information transfer unit 232 determines the node identifier of a node that is connected by an edge to one or more nodes identified by the one or more determined node identifiers, to which feature information is transferred, and is to fire.

The information transfer unit 232 performs information transfer processing, which is processing performed to transfer feature information from one firing node to the next firing node that is to fire. The next firing node is the node that is connected to the one firing node by an edge and is judged to be a node that is to fire.

The information transfer unit 232 acquires node information regarding nodes connected to one firing node by edges. Next, the information transfer unit 232 judges whether or not the node information satisfies the firing condition. Thereafter, the information transfer unit 232 forms and accumulates firing information that contains the node identifier contained in the node information that satisfies the firing condition.

For example, when the information transfer unit 232 judges that the node information satisfies the firing condition, the information transfer unit 232 judges whether or not the node is to fire based on the probability indicated by the firing probability information contained in the node information. Thereafter, when it is judged that the firing condition is satisfied and the node is to fire based on the probability indicated by the firing probability information, the information transfer unit 232 forms and accumulates firing information containing the node identifier contained in the node information.

It is preferable that the information transfer unit 232 changes the processing time for performing information transfer processing in accordance with the temperature information accepted by the temperature acceptance unit 222. For example, when the temperature information indicates a high temperature, the information transfer unit 232 performs information transfer processing more quickly than when the temperature information indicates a lower temperature. For example, when the temperature information indicates a low temperature, the information transfer unit 232 delays information transfer processing compared to when the temperature information indicates a higher temperature. For example, when a delay condition is satisfied, the information transfer unit 232 delays information transfer processing for a predetermined time. Delaying the information transmission processing may be waiting for a predetermined period of time, for example. Note that the delay condition is a condition for delaying processing, and is based on temperature information. The delay condition is, for example, “temperature information<=threshold value” or “temperature information<threshold value”.

It is preferable that the information transfer unit 232 increases the firing probability information contained in the node information regarding the firing node. This is in order to make it easier for the nodes to fire as more nodes fire.

The firing pattern acquisition unit 233 acquires a firing pattern using the one or more node identifiers determined by the information transfer unit 232. The firing pattern is a set of pieces of information that specify one or more firing nodes. The firing pattern is typically information that specifies nodes that fire simultaneously. The firing pattern contains one or more node identifiers.

It is preferable that the firing pattern acquisition unit 233 acquires an firing pattern that contains one or more node identifiers of the one or more nodes that finally fired. The nodes that finally fired are nodes that, among the fired nodes, did not transfer information to other nodes connected by edges.

The output information acquisition unit 234 acquires output information corresponding to the firing pattern acquired by the firing pattern acquisition unit 233. For example, the output information acquisition unit 234 references one or more pieces of output management information stored in the storage unit 21, and acquires output information corresponding to the output condition satisfied by the firing pattern acquired by the firing pattern acquisition unit 233.

For example, the output information acquisition unit 234 references one or more pieces of output management information stored in the storage unit 21, and determines a firing pattern corresponding to the output condition satisfied by the firing pattern acquired by the firing pattern acquisition unit 233. Next, for example, the output information acquisition unit 234 determines whether or not to acquire the output information according to the probability that is based on the output probability information that is paired with the determined firing pattern, and if it is determined to acquire the output information, the output information acquisition unit 234 acquires the output information contained in the output management information.

The output unit 24 outputs various kinds of information. Examples of the various kinds of information include output information.

The information output unit 241 outputs the output information acquired by the output information acquisition unit 234. Here, “output” is a concept that encompasses displaying on a display screen, projection using a projector, printing by a printer, the output of a sound, transmission to an external device, accumulation on a recording medium, delivery of a processing result to another processing device or another program, and the like.

It is preferable that the storage unit 21 and the NN storage unit 114 are realized using a non-volatile recording medium, but they can be realized using a volatile recording medium.

There is no limitation on the process in which information is stored in the storage unit 21 or the like. For example, information may be stored in the storage unit 21 or the like via a recording medium, or information transmitted via a communication line or the like may be stored in the storage unit 21 or the like, or information input via an input device may be stored in the storage unit 21 or the like.

The acceptance unit 22, the information acceptance unit 221, and the temperature acceptance unit 222 can be realized using, for example, a camera, a microphone, a wireless or wired communication means, a broadcast receiving means, a device driver for the input means such as a touch panel or a keyboard, or control software or the like for controlling the menu screen.

The processing unit 23, the feature acquisition unit 231, the information transfer unit 232, the firing pattern acquisition unit 233, and the output information acquisition unit 234 are typically realized using a processor, a memory, and so on. The processing procedures performed by the processing unit 23 and so on are typically realized using software, and the software is recorded on a recording medium such as a ROM. However, such processing procedures may be realized using hardware (a dedicated circuit). Note that the processor may be a CPU, an MPU, a GPU, or the like, and there is no limitation on the type thereof.

The output unit 24 and the information output unit 241 may be regarded as including or not including an output device such as a display or a speaker. The output unit 24 and so on can be realized using the driver software of the output device, the driver software of the output device and the output device, or the like. The output unit 24 and so on are, for example, constituted by a robot.

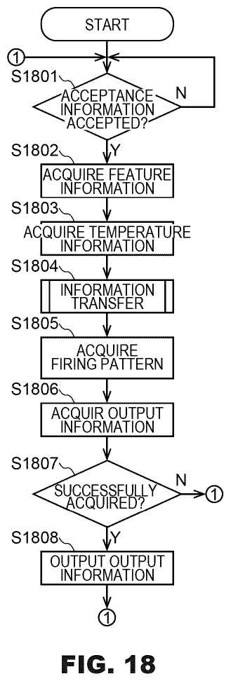

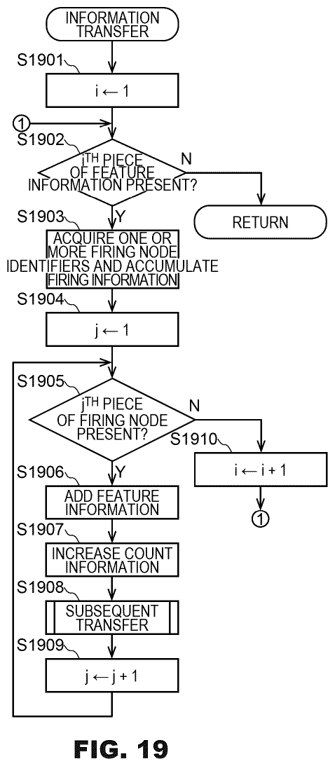

Next, examples of operations of the information processing apparatus 2 will be described with reference to the flowchart in FIG. 18.
(Step S1801) The information acceptance unit 221 judges whether or not acceptance information has been accepted. If acceptance information has been accepted, processing proceeds to step S1802, and if acceptance information has not been accepted, processing returns to step S1801.
(Step S1802) The feature acquisition unit 231 acquires one or more pieces of feature information from the acceptance information accepted in step S1801. For example, the feature acquisition unit 231 acquires one or more pieces of feature information from the image information accepted in step S1801. For example, the feature acquisition unit 231 acquires one or more pieces of feature information from the sound information accepted in step S1801.
(Step S1803) The temperature acceptance unit 222 acquires temperature information.
(Step S1804) The information transfer unit 232 performs information transfer processing within the neural network. An example of information transfer processing will be described with reference to the flowchart in FIG. 19.
(Step S1805) The firing pattern acquisition unit 233 acquires a firing pattern that contains the one or more node identifiers of the one or more nodes that fired last in step S1804. Note that the nodes that fired last are nodes that fired and did not transfer the feature information to other nodes.
(Step S1806) The output information acquisition unit 234 acquires output information corresponding to the firing pattern acquired in step S1805.
(Step S1807) If the output information has been successfully acquired in step S1806, processing proceeds to step S1808, and otherwise processing returns to step S1801.
(Step S1808) The information output unit 241 outputs the information acquired in step S1806. Processing returns to step S1801.

Note that in the flowchart in FIG. 18, the processing unit 23 may include the state determination unit 137 and the growth unit 138 and perform the growth processing described above.

In the flowchart shown in FIG. 18, processing is terminated when power is turned off or an interruption is made to terminate the processing.

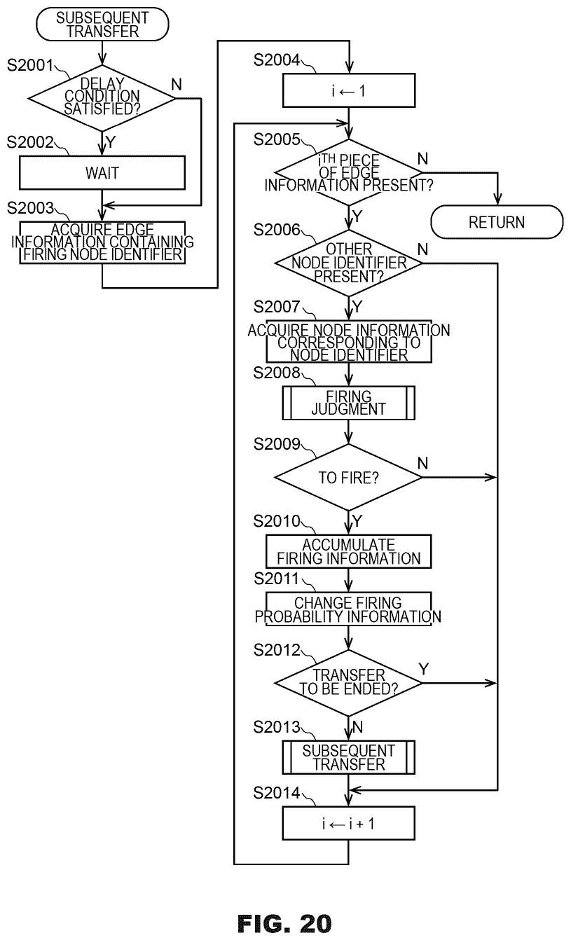

Next, an example of the information transfer processing in step S1804 will be described with reference to the flowchart in FIG. 19.
(Step S1901) The information transfer unit 232 substitutes 1 for the counter i.
(Step S1902) The information transfer unit 232 judges whether or not the i^{th} piece of feature information is present in the pieces of feature information acquired in step S1802. If the i^{th} piece of feature information is present, processing proceeds to step S1903, and otherwise processing returns to higher level processing.
(Step S1903) The information transfer unit 232 references one or more pieces of firing start point information in the storage unit 21, and acquires the one or more node identifiers contained in the one or more pieces of firing start point information satisfied by the i^{th} feature information. The information transfer unit 232 forms firing information that contains the node identifiers, and accumulates it in the storage unit 21. It is preferable that the information transfer unit 232 acquires timer information indicating the points in time of firing from a clock (not shown), forms firing information containing the timer information and the node identifiers, and accumulates it in the storage unit 21. Such one or more node identifiers are the identifiers of the nodes that fire in the first stage. Such node identifiers are firing node identifiers. Here, the information transfer unit 232 does not necessarily have to acquire firing node identifiers.
(Step S1904) The information transfer unit 232 substitutes 1 for the counter j.
(Step S1905) The information transfer unit 232 judges whether or not the j^{th} firing node identifier is present in the firing node identifiers acquired in step S1903. If the j^{th} firing node identifier is present, processing proceeds to step S1906, and otherwise processing proceeds to step S1910.
(Step S1906) The information transfer unit 232 performs processing to add the i^{th} piece of feature information to the node identified by the j^{th} firing node identifier. Note that the processing performed to add the i^{th} piece of feature information to the node is, for example, processing performed to write the i^{th} piece of feature information into the node information regarding the node, or processing performed to associate the i^{th} piece of feature information with the node information regarding the node.
(Step S1907) The information transfer unit 232 performs an update to increase the count information contained in the node information corresponding to the j^{th} firing node identifier. For example, the information transfer unit 232 reads out the count information contained in the node information corresponding to the j^{th} firing node identifier, and overwrites the count information with count information obtained by adding 1 to the count information.
(Step S1908) The information transfer unit 232 performs subsequent transfer processing where the j^{th} firing node identifier is the node-of-interest identifier. An example of subsequent transfer processing will be described with reference to the flowchart in FIG. 20.

Note that the subsequent transfer processing is processing performed to transfer feature information for the node identified by the node-of-interest identifier to a destination node that is connected to the node identified by the node-of-interest identifier via an edge and that is to fire. Note that the processing performed to transfer feature information is information transfer processing.
(Step S1909) The information transfer unit 232 increments the counter j by 1. Processing returns to step S1905.
(Step S1910) The information transfer unit 232 increments the counter i by 1. Processing returns to step S1902.

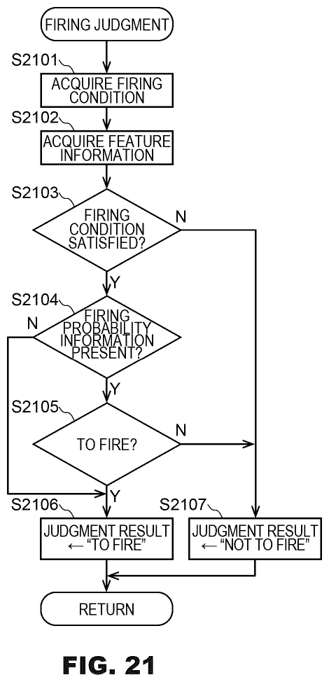

Next, an example of the subsequent transfer processing in step S1908 will be described with reference to the flowchart in FIG. 20.
(Step S2001) The information transfer unit 232 judges whether or not the acquired temperature information matches the delay condition. If the delay condition is satisfied, processing proceeds to step S2002, and if the delay condition is not satisfied, processing proceeds to step S2003.
(Step S2002) The information transfer unit 232 waits. It is preferable that the wait time is determined in advance, but there is no limitation.
(Step S2003) The information transfer unit 232 acquires all the pieces of edge information that contain the firing node identifier of interest from the NN storage unit 114.
(Step S2004) The information transfer unit 232 substitutes 1 for the counter i.
(Step S2005) The information transfer unit 232 judges whether or not the i^{th} piece of edge information is present in the pieces of edge information acquired in step S2001. If the i^{th} piece of edge information is present, processing proceeds to step S2006, and otherwise processing returns to higher level processing.
(Step S2006) The information transfer unit 232 judges whether or not the node identifier of another node is present in the i^{th} edge information. If the node identifier of another node is present, processing proceeds to step S2007, and otherwise processing proceeds to step S2014. Note that the node identifier of another node in the edge information is the node identifier of the connection destination node of the edge. The case where the node identifier of another node is present in the i^{th} edge information is the case where the edge is connected to two nodes.
(Step S2007) The information transfer unit 232 acquires the node identifier of the other node in the i^{th} piece of edge information. Next, the information transfer unit 232 acquires, from the NN storage unit 114, the node information regarding the node identified by the node identifier.
(Step S2008) Using the node information acquired in step S2007, the information transfer unit 232 judges whether or not the node corresponding to the node information fires. An example of such firing judgment processing will be described with reference to the flowchart in FIG. 21.
(Step S2009) If the judgment result in step S2008 is “to fire”, the information transfer unit 232 proceeds to step S2010, and if the judgment result is “not to fire”, the information transfer unit 232 proceeds to step S2014.
(Step S2010) The information transfer unit 232 acquires firing information that contains the node identifier contained in the node information acquired in step S2007, and accumulates the firing information in the storage unit 11.
(Step S2011) The information transfer unit 232 changes the firing probability information contained in the node information acquired in step S2007. Here, the information transfer unit 232 changes the firing probability information so that the firing probability specified by the firing probability information increases.
(Step S2012) The information transfer unit 232 judges whether or not to end the transfer of information between the nodes. If the transfer is to be ended, processing proceeds to step S2014, and if the transfer is not to be ended, processing proceeds to step S2013. Note that when the transfer is to be terminated is, for example, when the node is a terminal node in the NN. In addition, when the transfer is to be ended, the node identifiers contained in the firing information accumulated immediately before in step S2010 are the node identifiers to be included in the firing pattern.
(Step S2013) The information transfer unit 232 performs subsequent transfer processing where the node is the node of interest. An example of subsequent transfer processing is shown in FIG. 20.
(Step S2014) The information transfer unit 232 increments the counter i by 1. Processing returns to step S2005.

In the flowchart in FIG. 20, it is preferable that, when transferring information between nodes, the information transfer unit 232 updates the retained energy amount information to one that has been obtained by reducing the amount of energy indicated by the retained energy amount information contained in the firing origin node information. The same may also be applied to the retained energy amount information that is paired with the axon identifier of the axon used for the transfer, and the retained energy amount information that is paired with the dendrite identifier of the dendrite used for the transfer. In addition, it is assumed that the function for reducing the amount of energy is stored in the storage unit 21, for example. There is no limitation on the function. The function is a well-known technique, and therefore a detailed description will be omitted.

Next, an example of the firing judgment processing in step S2008 will be described with reference to the flowchart in FIG. 21.
(Step S2101) The information transfer unit 232 acquires a firing condition corresponding to the node information acquired in step S2005. Note that the firing condition may be different for each node, or may be common to two or more nodes.
(Step S2102) The information transfer unit 232 acquires one or more pieces of feature information. Note that the one or more pieces of feature information here are pieces of feature information transferred from the firing origin node.
(Step S2103) The information transfer unit 232 judges whether or not the one or more pieces of feature information acquired in step S2102 satisfy the firing condition acquired in step S2101. If the firing condition is satisfied, processing proceeds to step S2104, and if the firing condition is not satisfied, processing proceeds to step S2107.
(Step S2104) The information transfer unit 232 judges whether or not the node information of interest contains firing probability information. If the firing probability information is contained, processing proceeds to step S2105, and if firing probability information is not contained, processing proceeds to step S2106.
(Step S2105) The information transfer unit 232 acquires the firing probability information contained in the node information of interest. Next, using the firing probability information, the information transfer unit 232 judges whether or not the node is to fire. If the node is to fire, processing proceeds to step S2106, and if the node is not to fire, processing proceeds to step S2107.
(Step S2106) The information transfer unit 232 substitutes “to fire” for the judgment result. Processing returns to higher level processing.
(Step S2107) The information transfer unit 232 substitutes “not to fire” for the judgment result. Processing returns to higher level processing.

As described above, with the present embodiment, it is possible to simulate the operation of a grown brain. That is to say, the information processing apparatus 2 can simulate the brain's response to accepted information using the NN information formed by the NN growth apparatus 1. In particular, with the information processing apparatus 2, it is possible to simulate, for example, the brain activity of a person after infancy.

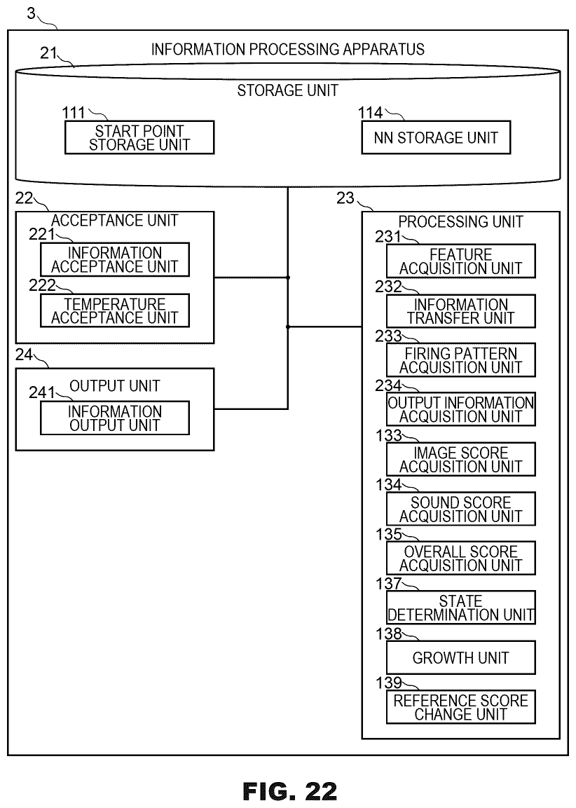

Note that in the present embodiment, the information processing apparatus may realize the growth processing performed by the NN growth apparatus 1. In this case, the information processing apparatus can output output information corresponding to the accepted acceptance information while growing the neural network. The information processing apparatus in such a case is an information processing apparatus 3. The processing unit 23 of the information processing apparatus 3 includes the image score acquisition unit 133, the sound score acquisition unit 134, the overall score acquisition unit 135, the firing node determination unit 136, the state determination unit 137, the growth unit 138 and the reference score change unit 139 included in the NN growth apparatus 1 in addition to the configuration of the information processing apparatus 2. A block diagram for the information processing apparatus 3 in such a case is shown in FIG. 22.

In FIG. 22, the processing performed by the firing node determination unit 136 of the NN growth apparatus 1 is performed by the information transfer unit 232. The feature acquisition unit 231 has a configuration formed by combining the image feature acquisition unit 131 and the sound feature acquisition unit 132.

The software that realizes the information processing apparatus 2 according to the present embodiment is the program described below. That is to say, this program is a program that enables a computer that can access an NN storage unit in which neural network information accumulated by an NN growth apparatus 1 is stored, to function as: an information acceptance unit that accepts acceptance information that is at least one of image information and sound information; a feature acquisition unit that acquires one or more pieces of feature information corresponding to the acceptance information accepted by the information acceptance unit; an information transfer unit that determines one or more node identifiers of one or more firing nodes, corresponding to the one or more pieces of feature information acquired by the feature acquisition unit, from a start point storage unit in which one or more pieces of firing start point information are stored, each piece of firing start point information containing an information identifier that identifies feature information of acceptance information and one or more node identifiers that identify nodes that initially fire when the feature information is accepted, and determines a node identifier of a firing node that is connected to the one or more nodes identified by the one or more node identifiers by edges and to which the feature information is to be transferred; a firing pattern acquisition unit that acquires a firing pattern using the one or more node identifiers determined by the information transfer unit; an output information acquisition unit that acquires output information corresponding to the firing pattern acquired by the firing pattern acquisition unit; and an information output unit that outputs the output information.

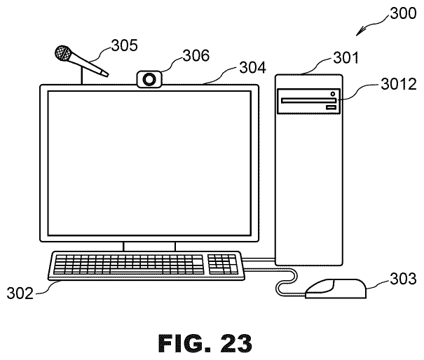

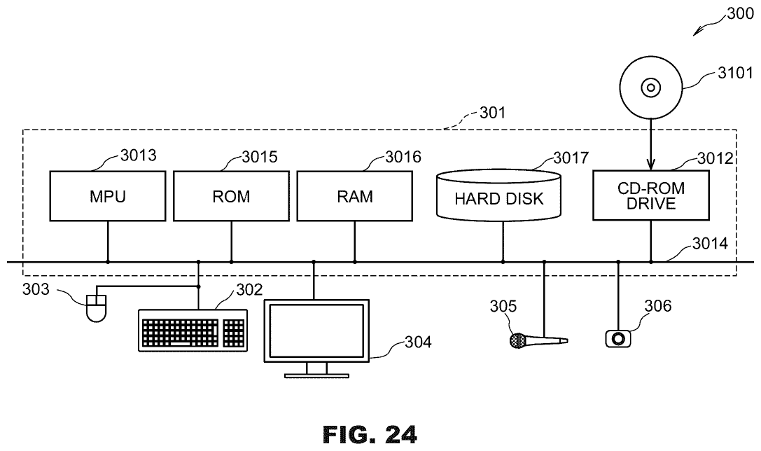

FIG. 23 shows an external appearance of a computer that executes the program described in the present description and realizes the NN growth apparatus 1, the information processing apparatus 2 and the information processing apparatus 3 according to the various embodiments described above. The above-described embodiments can be realized using computer hardware and a computer program executed thereon. FIG. 23 is an overview diagram for this computer system 300, and FIG. 24 is a block diagram for the system 300.

In FIG. 23, the computer system 300 includes a computer 301 that includes a CD-ROM drive, a keyboard 302, a mouse 303, a monitor 304, a microphone 305, and a camera 306.

In FIG. 24, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the figure, the computer 301 may further include a network card that provides connection to a LAN.

The program that enables the computer system 300 to perform the functions of the NN growth apparatus 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the NN growth apparatus 1 and so on according to the embodiments described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means that are present in one device may be physically realized using one medium.

Also, in the above-described embodiments, each kind of processing may be realized as centralized processing that is performed by a single device, or distributed processing that is performed by multiple devices.

As a matter of course, the present invention is not limited to the above-described embodiments, and various changes are possible, and such variations are also included within the scope of the present invention.

### INDUSTRIAL APPLICABILITY

As described above, the NN growth apparatus according to the present invention has the effect of being able to simulate infant brain growth, and is useful as an NN growth apparatus or the like.

1. An NN growth apparatus comprising:
an NN storage unit in which neural network information is stored, the neural network information containing two or more pieces of node information each containing a node identifier, and one or more pieces of edge information each containing an edge identifier and specifying a connection between nodes;
a start point storage unit in which one or more pieces of firing start point information each containing one or more node identifiers identifying nodes that fire without going through other nodes are stored, in association with an initial firing condition that is a condition related to one or more kinds of feature information of one or more pieces of image feature information for image information and one or more pieces of sound feature information for sound information, and that is a condition for determining nodes that fire without going through other nodes;
a reference score storage unit in which a reference score related to a positive state or a negative state is stored;
an information acceptance unit that accepts image information and sound information;
an image feature acquisition unit that acquires, using the image information accepted by the information acceptance unit, one or more pieces of image feature information corresponding to the image information;
a sound feature acquisition unit that acquires, using the sound information accepted by the information acceptance unit, one or more pieces of sound feature information corresponding to the sound information;
an overall score acquisition unit that acquires an overall score based on the one or more pieces of image feature information and the one or more pieces of sound feature information;
a firing node determination unit that determines, from the start point storage unit, one or more node identifiers paired with the initial firing condition that matches one or more kinds of information of the one or more pieces of image feature information and the one or more pieces of sound feature information, and determines, for each of the nodes identified by the one or more node identifiers, a node identifier of a firing node that is connected by an edge, receives one or more kinds of information of the one or more pieces of image feature information and the one or more pieces of sound feature information; and
a growth unit that performs growth processing to grow edge information of one or more edges connected to each of one or more nodes identified by one or more node identifiers of the one or more node identifiers determined by the firing node determination unit, based on difference information regarding a difference between the overall score and the reference score.

2. The NN growth apparatus according to claim 1, further comprising:
an image score acquisition unit that acquires an image score that is a score related to positive and negative states, using the one or more pieces of image feature information;
and
a sound score acquisition unit that acquires a sound score that is a score related to positive and negative states, using the one or more pieces of sound feature information,
wherein the overall score acquisition unit uses the image score and the sound score to acquire the overall score.

3. The NN growth apparatus according to claim 1,
wherein the edge information contains a weight,
the firing node determination unit determines a node identifier of a node that is connected by an edge whose weight satisfies a transfer condition, and
the growth unit performs first edge growth processing to acquire difference information regarding a difference between the overall score and the reference score, and to increase the weight of the edge information of each of the one or more edges when the difference information matches a first edge growth condition.

4. The NN growth apparatus according to claim 1,
wherein the edge information may contain edge position information that specifies a position of an end point of an edge, and
the growth unit performs second edge growth processing to acquire difference information regarding a difference between the overall score and the reference score, and to change the edge position information contained in the edge information of each of the one or more edges when the difference information matches a second edge growth condition, thereby increasing a length of each edge.

5. The NN growth apparatus according to claim 4, further comprising:
a goal storage unit in which pieces of goal information are stored, the pieces of goal information specifying goals respectively corresponding to two or more states that include positive and negative states; and
a state determination unit that determines one state from the two or more states including the positive and negative states, using the difference information acquired by the growth unit,
wherein the pieces of goal information each contain goal position information that specifies a position of the goal corresponding thereto, or goal direction information that indicates a direction of the goal, and
the growth unit performs the second edge growth processing to acquire the goal information paired with the one state determined by the state determination unit, to change the edge position information contained in the edge information of each of the one or more edges, to acquire a new piece of edge position information in the direction indicated by the goal information, and to accumulate the new piece of edge position information.

6. The NN growth apparatus according to claim 1, further comprising:
a reference score change unit that changes the reference score in the reference score storage unit based on the overall score acquired by the overall score acquisition unit.

7. The NN growth apparatus according to claim 6,
wherein the reference score change unit changes the reference score in the reference score storage unit only when the overall score matches a score change condition.

8. The NN growth apparatus according to claim 1,
wherein the reference score storage unit stores a reference score paired with one or more firing patterns that use one or more node identifiers, and
the growth unit acquires the reference score paired with the firing pattern corresponding to the one or more node identifiers determined by the firing node determination unit from the reference score storage unit, acquires difference information regarding a difference between the overall score and the reference score, and performs the growth processing based on the difference information.

9. The NN growth apparatus according to claim 1,
wherein the firing node determination unit judges whether or not one or more pieces of feature information transferred from one or more other nodes connected by edges satisfy one or more firing conditions related to the feature information, and determines the node identifier of a node judged to satisfy the firing conditions.

10. The NN growth apparatus according to claim 1,
wherein the node information contains node position information that specifies a position of the node,
the NN growth apparatus further comprises:
a goal storage unit in which pieces of goal information are stored, the pieces of goal information specifying goals respectively corresponding to two or more states that include positive and negative states; and
a state determination unit that determines one state from the two or more states including the positive and negative states, using the difference information acquired by the growth unit, and
the growth unit acquires difference information regarding a difference between the overall score and the reference score, and, based on the difference information, performs edge generation processing to generate and accumulate edge information corresponding to one or more edges extending from one or more nodes identified by one or more node identifiers of the one or more node identifies determined by the firing node determination unit in a direction indicated by the goal information paired with the one state determined by the state determination unit.

11. The NN growth apparatus according to claim 10,
wherein the firing node determination unit accumulates count information related to a count of the determined node identifiers in association with the node identifiers, and
the growth unit performs the edge generation processing on a node identified by a node identifier corresponding to the count information that matches an edge generation condition.

12. The NN growth apparatus according to claim 1,
wherein each node is a soma,
the edges include an axon and a dendrite, and
the edge information contains axon information that contains an axon identifier and axon position information indicating a position of the axon, and dendrite information that contains a dendrite identifier and dendrite position information indicating a position of the dendrite.

13. An information processing apparatus comprising:
an NN storage unit in which neural network information accumulated by the NN growth apparatus according to claim 1 is stored;
an information acceptance unit that accepts acceptance information that is one or more kinds of information selected from the group consisting of image information and sound information;
a feature acquisition unit that acquires one or more pieces of feature information corresponding to the acceptance information accepted by the information acceptance unit;
an information transfer unit that determines one or more node identifiers of one or more firing nodes, corresponding to the one or more pieces of feature information acquired by the feature acquisition unit, from a start point storage unit in which one or more pieces of firing start point information are stored, each piece of firing start point information containing an information identifier that identifies feature information of acceptance information and one or more node identifiers that identify nodes that fire without going through other nodes when the feature information is accepted, and determines a node identifier of a firing node that is connected to the one or more nodes identified by the one or more node identifiers by edges and to which the feature information is to be transferred;
a firing pattern acquisition unit that acquires a firing pattern using the one or more node identifiers determined by the information transfer unit;
an output information acquisition unit that acquires output information corresponding to the firing pattern acquired by the firing pattern acquisition unit; and
an information output unit that outputs the output information.

14. The information processing apparatus according to claim 13, further comprising:
a temperature acceptance unit that accepts temperature information,
wherein the information transfer unit performs information transfer processing to transfer, from a node that has fired, the feature information corresponding to the node that has fired, to a node that is to fire next, and changes a processing time for the information transfer processing based on the temperature information accepted by the temperature acceptance unit.

15. A method for producing neural network information, realized using: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information each containing one or more node identifiers identifying nodes that fire without going through other nodes are stored, in association with an initial firing condition that is a condition related to one or more kinds of feature information of one or more pieces of image feature information for image information and one or more pieces of sound feature information for sound information, and that is a condition for determining nodes that fire without going through other nodes; a reference score storage unit in which a reference score related to positive and negative states is stored: an information acceptance unit; an image feature acquisition unit; a sound feature acquisition unit; an overall score acquisition unit; a firing node determination unit; and a growth unit, the method comprising:
an information acceptance step in which the information acceptance unit accepts image information and sound information;
an image feature acquisition step in which the image feature acquisition unit acquires, using the image information accepted in the information acceptance step, one or more pieces of image feature information corresponding to the image information;
a sound feature acquisition step in which the sound feature acquisition unit acquires, using the sound information accepted in the information acceptance step, one or more pieces of sound feature information corresponding to the sound information;
an overall score acquisition step in which the overall score acquisition unit acquires an overall score based on the one or more pieces of image feature information and the one or more pieces of sound feature information;
a firing node determination step in which the firing node determination unit determines, from the start point storage unit, one or more node identifiers paired with the initial firing condition that matches one or more kinds of information of the one or more pieces of image feature information and the one or more pieces of sound feature information, and determines, for each of the nodes identified by the one or more node identifiers, a node identifier of a firing node that is connected by an edge, receives one or more kinds of information of the one or more pieces of image feature information and the one or more pieces of sound feature information; and
a growth step in which the growth unit performs growth processing to grow edge information of one or more edges connected to each of one or more nodes identified by one or more node identifiers of the one or more node identifiers determined in the firing node determination unit, based on difference information regarding a difference between the overall score and the reference score.

16. A non-transitory computer readable medium storing a program that enables a computer that can access: an NN storage unit in which neural network information is stored, the neural network information containing two or more pieces of node information each containing a node identifier, and one or more pieces of edge information each containing an edge identifier and specifying a connection between nodes; a start point storage unit in which one or more pieces of firing start point information each containing one or more node identifiers identifying nodes that fire without going through other nodes are stored, in association with an initial firing condition that is a condition related to one or more kinds of feature information of one or more pieces of image feature information for image information and one or more pieces of sound feature information for sound information, and that is a condition for determining nodes that fire without going through other nodes; and a reference score storage unit in which a reference score related to positive and negative states is stored, to function as:
an information acceptance unit that accepts image information and sound information;
an image feature acquisition unit that acquires, using the image information accepted by the information acceptance unit, one or more pieces of image feature information corresponding to the image information;
a sound feature acquisition unit that acquires, using the sound information accepted by the information acceptance unit, one or more pieces of sound feature information corresponding to the sound information; and
an overall score acquisition unit that acquires an overall score based on the one or more pieces of image feature information and the one or more pieces of sound feature information;
a firing node determination unit that determines, from the start point storage unit, one or more node identifiers paired with the initial firing condition satisfied by one or more kinds of information of the one or more pieces of image feature information and the one or more pieces of sound feature information, and determines, for each of the nodes identified by the one or more node identifiers, a node identifier of a firing node that is connected by an edge, receives one or more kinds of information of the one or more pieces of image feature information and the one or more pieces of sound feature information; and
a growth unit that performs growth processing to grow edge information of one or more edges connected to each of one or more nodes identified by one or more node identifiers of the one or more node identifiers determined by the firing node determination unit, based on difference information regarding a difference between the overall score and the reference score.
